(19) United States
(12) Patent Application Publication
(10) Pub. No.: US 2016/0329118 A1
(43) Pub. Date: Nov. 10, 2016

(54) Machine to detect Phonon Gain to Control Desired Reactions in an Electrically Driven Hydrogen Loaded Material

(71) Applicant: Mitchell R. Swartz, Weston, MA (US)

(72) Inventor: Mitchell R. Swartz, Weston, MA (US)

(21) Appl. No.: 14/545,475

(22) Filed: May 8, 2015

(51) Int. Cl. G21D 3/08; G21D 7/00; G21B 3/00

(52) U.S. Cl. CPC G21D 3/08; G21B 3/00; G21D 7/00

(57) ABSTRACT

A machine to detect phonon gain to control desired reactions using a container with at least two optical ports, a power supply and wiring connections to enable driving a material sample to be examined, a power supply to drive at least two lasers, a controller to regulate the output of the lasers, a beam path to enable illumination of the sample, a controller to regulate the electric power delivered to the sample enabling driving in more than one state, a detector system to examine the backscatter radiation from the sample by frequency, a second beam path to enable the backscatter to reach the detector system, a computation system to separate and determine the ratios of the examined backscattered frequencies to determine the intensities and distribution, and a second computation system to compare the examined intensities and distribution and ratios to the desired intensities and distribution and ratios to determine what states were detected and to derive changes for the power supply driving the sample.

### CROSS REFERENCE TO RELATED APPLICATIONS

This is a Continuation-in-part of Ser. No. 07/339,976 Filed: Apr. 18, 1989

### STATEMENT REGARDING FEDERALLY SPONSORED RESEARCH OR DEVELOPMENT

Not Applicable

### DESCRIPTION OF ATTACHED APPENDIX

Peer-reviewed publications as Exhibits attesting to Operability, Utility and the like

### OTHER PATENTS AND PUBLICATIONS

By way of background and to place reasonable limits on the size of this disclosure, the following references and articles may be used by way of background material and to supplement this specification. Because reference is made to the following articles with a description of patterns of failure and their relation to loading, materials, methods, and terms discussed below, which may be employed in the discussion and claims of the present application, the cited references are incorporated as if included herein.
1. Swartz, M. P. Hagelstein, G. Verner, Impact of Electrical Avalanche Through a ZrO₂-NiD Nanostructured CF/LANR Component on its Incremental Excess Power Gain”, ICCF-19, Padua, Italy (Apr. 16, 2015)
2. Swartz, M. G. Verner, J. Tolleson, P. Hagelstein, Dry, preloaded NANOR®-type CF/LANR components, Current Science, 108, 4, 595 (2015).
3. Swartz M., Verner, G., et al., Imaging of an Active NANOR®-type LANR Component using CR-39, J. Condensed Matter Nucl. Sci. 15, (2015), p 81; www.iscmns.org/CMNS/JCMNS-Vol15.pdf
4. Swartz M., Incremental High Energy Emission from a ZrO₂-PdD Nanostructured Quantum Electronic Component CF/LANR, J. Condensed Matter Nucl. Sci. 15, (2015), p 92; www.iscmns.org/CMNS/JCMNS-Vol15.pdf
5. Swartz M., Verner, G., et al., Amplification and Restoration of Energy Gain Using Fractionated Magnetic Fields on ZrO₂-PdD Nanostructured Components, J. Condensed Matter Nucl. Sci. 15, (2015), p 66; www.iscmns.org/CMNS/JCMNS-Vol15.pdf
6. Swartz M. R., Hagelstein P. I., Demonstration of Energy Gain from a Preloaded ZrO₂—PdD Nanostructured CF/LANR Quantum Electronic Device at MIT, J Condensed Matter Nucl. Sci. 13, (2014), p 516 www.iscmns.org/CMNS/JCMNS-Vol13.pdf
7. Swartz M. R., Verner G., et al., Energy Gain From Preloaded ZrO₂—PdNi-D Nanostructured CF/LANR Quantum Electronic Components, J. Condensed Matter Nucl. Sci. 13, (2014), p 528 www.iscmns.org/CMNS/JCMNS-Vol13.pdf
8. Swartz M. R., Impact of an Applied Magnetic Field on a High Impedance Dual Anode LANR Device, J. Condensed Matter Nucl. Sci. 4, (2011), p 93; 239th American Chemical Society National Meeting and Exposition in San Francisco (2011).www.iscmns.org/CMNS/JCMNS-Vol4.pdf
9. Swartz M., Verner G., et al., Non-Thermal Near-IR Emission from High Impedance and Codeposition LANR Devices, Proc. ICCF14 1, (2008), p 343; Ed D. J. Nagel and M. E. Melich, ISBN: 978-0-578-06694-3, 343, (2010); www.iscmns.org/iccf14/ProcICCF14a.pdf
10. Swartz M., Verner G., The Phusor®-type LANR Cathode is a Metamaterial Creating Deuteron Flux for Excess Power Gain, Proc. ICCF14 2, (2008), p 458; Ed D. J. Nagel and M. E. Melich, ISBN: 978-0-578-06694-3, 458, (2010); www.iscmns.org/iccf14/ProcICCF14b.pdf
11. Swartz M., Excess Power Gain using High Impedance and Codepositional LANR DevicesMonitored by calorimetry, Heat Flow, and Paired Stirling Engines, Proc. ICCF14 1, (2008), p 123; Ed D. J. Nagel and M. E. Melich, ISBN: 978-0-578-06694-3, 123, (2010); www.iscmns.org/iccf14/ProcICCF14a.pdf
12. Swartz, M., Bass, R. W., “Empirical System Identification (ESID) and Optimal Control of Lattice-AssistedNuclear Reactors,” Proceedings of the 14th International Conference on Condensed Matter Nuclear Science and the 14th International Conference on Cold Fusion (ICCF-14), Ed D. J. Nagel and M. E. Melich, ISBN: 978-0-578-06694-3, 497, (2010).
13. Swartz, M., “Survey of the Observed Excess Energy and Emissions In Lattice Assisted Nuclear Reactions”, Journal of Scientific Exploration, 23, 4, 419-436 (2009).
14. Swartz, M., G. Verner, “Excess Heat from Low Electrical Conductivity Heavy Water Spiral-Wound Pd/D2O/Pt and Pd/D2O—PdCl2/Pt Devices”, Condensed Matter Nuclear Science, Proceedings of ICCF-10, eds. Peter L. Hagelstein, Scott, R. Chubb, World Scientific Publishing, NJ, ISBN 981-256-564-6, 29-44; 45-54 (2006).
15. Swartz, M., “Can a Pd/D2O/Pt Device be Made Portable to Demonstrate the Optimal Operating Point?”, Condensed Matter Nuclear Science, Proceedings of ICCF-10, eds. Peter L. Hagelstein, Scott, R. Chubb, World Scientific Publishing, NJ, ISBN 981-256-564-6, 29-44; 45-54 (2006).
16. Swartz, M., “Photoinduced Excess Heat from Laser-Irradiated Electrically-Polarized Palladium Cathodes in D2O”, Condensed Matter Nuclear Science, Proc. ICCF-10, eds. Peter L. Hagelstein, Scott Chubb, N J, ISBN 981-256-564-6, 213-226 (2006).
17. Swartz. M., “The Impact of Heavy Water (D2O) on Nickel-Light Water Cold Fusion Systems”, Proceedings of the 9th International Conference on Cold Fusion (Condensed Matter Nuclear Science), Beijing, China, Xing Z. Li, pages 335-342. May (2002).
18. Swartz. M., “Dances with Protons—Ferroelectric Inscriptions in Water/Ice Relevant to Cold Fusion and Some Energy Systems”, Infinite Energy, 44, (2002).
19. Swartz M., G. Verner Bremsstrahlung—Relative Role In Hot And Cold Fusion And Impact Upon Potential Isotopic Fuels, J. New Energy 3, No. 4, (1998), p 90-101 www.iscmns.org/FIC/J/JNE3N4.pdf
20. Swartz. M., “Patterns of Failure in Cold Fusion Experiments”, Proceedings of the 33RD Intersociety Engineering Conference on Energy Conversion, IECEC-98-1229, Colorado Springs, Colo., Aug. 2-6, (1998).
21. Swartz. M., “Consistency of the Biphasic Nature of Excess Enthalpy in Solid State Anomalous Phenomena with the Quasi-1-Dimensional Model of Isotope Loading into a Material”, Fusion Technology, 31, 63-74 (1997).
22. Swartz. M., “Codeposition Of Palladium And Deuterium”, Fusion Technology, 32, 126-130 (1997).
23. Swartz, M., “Phusons in Nuclear Reactions in Solids”, Fusion Technology, 31, 228-236 (March 1997).
24. Swartz M., Deuterium Production and Light Water Excess Enthalpy Experiments using Nickel Cathodes, J. New Energy 1, No. 3, (1996), p 219 www.iscmns.org/FIC/J/JNE1N3.pdf
25. Swartz M., Possible Deuterium Production from Light Water Excess Enthalpy Experiments Using Nickel Cathodes, J New Energy 1, No. 3, (1996), p 68-80; www.iscmns.org/FIC/J/JNE1N3.pdf
26. Swartz M., Isotopic Fuel Loading Coupled to Reactions at an Electrode, Proc. ICCF4 2, (1993), p 429; Fusion Technology, 26, 4T, 74-77 (1994); www.lenr-canr.org/acrobat/EPRIproceedinga.pdf
27. Swartz, M., “Quasi-One-Dimensional Model of Electrochemical Loading of Isotopic Fuel into a Metal”, Fusion Technology, 22, 2, 296-300 (1992).

### BACKGROUND OF THE INVENTION

The invention has relevance to electrolytically hydrogen-loaded materials, pressure loaded materials, and those materials which are “preloaded” with protons or deuterons already in place as an alloy (e.g. PdD, PdDₓ, NiD, TiD, TiDₓ, and the like; where the subscript refers to other than 1:1 atomic ratios) or nanostructured material.

Although Pd and Ni are mainly used in the preferred embodiment of the present invention, it also has relevance to other materials which load hydrogen, including Group VIII, Group IVb and Vb, and some rare earth, elements, including cerium, lanthanum, niobium, tantalum, thorium, vanadium, zirconium, and their alloys and composites and nanostructured materials constructed from these elements, alloys and composites.

The present invention is applicable to materials which do not exhibit excess heat (observable heat beyond that of a joule thermal control) or even heat, but are involved in dynamic processes such as lubrication, fluid flow, chemical reactors, medical testing, 3D-printing and the like.

In addition, the present invention has relevance to the search for an alternative to hydrocarbons to produce energy, with applications including heating, transportation, electricity production, medicine, including artificial organs, and space travel.

### Introduction to LANR

For many years, scientists and inventors have examined the heat released by some Group VIII metal hydrides (eg. Pd-D and Ni—H), which are very highly loaded with an isotope of hydrogen, that can catalyze highly desired lattice assisted reactions only occurring under difficult-to-achieve conditions. Some of these reactions are called “lattice assisted nuclear reactions” [LANR]. LANR offers incredibly efficient energy production, clean and free of pollution, all toxic emissions, all carbon footprints, all greenhouse gases, and radioactivity, while obviating fossil fuel. The fuel substrate is deuterium, plentiful from the oceans, and the major products are de novo, commensurate helium-4 and an extraordinary amount of heat (Swartz 13).

LANR is an engineering development which came after, and was derived from, cold fusion. Although the words “cold fusion” have a connotation based on the false notion that it and lattice related nuclear reactions do not exist, and that there is no nuclear chemistry in deuterated palladium alloys. However, this is not true. The burgeoning literature shows otherwise. In addition, many US agencies such as DTRA, DARPA, DIA, the US Navy, and hundreds of scientists disagree with any such false notions.

LANR work continues to advance in many countries. The occurrence of nuclear reactions in deuterium-loaded solids, such as palladium and titanium can no longer be reasonably denied. Significant positive results have been obtained in many laboratories (Swartz 13, 3, 4).

“Over 100 groups from more than 12 countries have now reported on various types of evidence for the occurrence of nuclear reactions in deuterium-loaded metals or compounds.” [F. Will; Final Report National Cold Fusion Inst. (1991)]
“Perhaps the clearest scientific fact, at this time, is the hardest for physicists to accept: nuclear reactions apparently do occur in deuterium-loaded Pd, Ti, and probably in other solids.”
[Office of Naval Research Asian Office, NAVSO P-3580, Vol. 18, January 1993].

### LANR Occurs in a Lattice

LANR involves a metal or alloy, like palladium, loaded fully with heavy hydrogen, obtained either from deuterons from heavy water or gaseous deuterium. Since 1989, two decades of LANR R&D, sub rosa, have confirmed that excess heat production (far above the input) accompanied by very low level, but measurable, emissions which can be driven, following loading, by an applied electric field and gas loading techniques. A few hundred credentialed scientists with diverse backgrounds have continued to conduct careful experiments as they performed detailed data analyses using improved instrumentation, equipment, calibration, and controls. No single error or combination of errors on the part of all of the scientists can explain the developing results.

As will be discussed in detail below, the deuterium, usually as deuterons, is driven into the metal by the applied electric field intensity or by gas pressure applied.

In the following, in one embodiment of the present invention, there is involved and used a palladium electrode which becomes fully loaded (filled) with deuterons which are obtained from deuterium oxide (heavy water) in which the electrode is positioned.

Loading refers to the volume (ratio) filling of the palladium with the lighter, isotopic hydrogen, which in the general preferred embodiment are deuterons. Successful production of the desired reactions is required for optimal performance of these systems, and the desired reactions require that there must be full filling (“loading”) of the palladium electrode by the deuterons, much as a sponge fills with water.

The desired reactions only fully occur when the metallic palladium is fully loaded, usually with enough deuterons obtained from the heavy water.

### Energy Produced in LANR

In LANR, excess heat and helium-4 production are the dominant reactions. Melvin Miles of China Lake with Johnson-Matthey Pd rods was the first to show the correlation of heat and helium-4 production. Arata and Zhang reported de novo He⁴ with LANR, including with Zr₂O₄/Pd powder exposed to deuterium gas, but not with hydrogen gas (Swartz 13).

The reaction is

D+D---->He⁴+˜22 MeV(transferred to the lattice as heat) Eq. 1

LANR success means that significant energy (think, E=mc² from the tiny difference between D₂ and He⁴) is released by “nuclear burning” of the deuterons of heavy water or D into de novo Helium-4. There is more heat released than if the entire cathode were substituted for an equivalent quantity of explosive, such as TNT, but in this case it is safe, clean, controllable and efficient.

One most important point is that even if one were to replace the entire cathode with TNT, one would only get 1.2 kilojoules on explosion. The excess energy observed with LANR is orders of magnitude greater than any known chemical reaction. Another important point is that from those high energy levels of He⁴* made in LANR comes the observed excess heat, only seen in those difficult-to-achieve loaded lattice conditions. These reactions are complex. Under some conditions, tritium and other emissions result, under select conditions, the desired reactions of considerable heat result; and under most conditions, nothing happens. Engineering enables the desired reactions, as discussed below.

The third most important point is that energy and momentum are conserved in LANR, and because of the unique relationship to the lattice, the helium generated is moving slowly, at low velocity, very unlike hot fusion. Thus, the He⁴ which is created is then retained in the cathode, only released at very high temperatures (˜850 C).

The fourth most important point is that the excess energy brings heat and changes wrought upon the electrode. SPAWAR, JWK, Stringham, Dash and others have reported volcano looking pits in electrodes (Swartz 13). These induced pits are important for two reasons. These features herald the requirement that a lot of local heat needed to produce the focal melting of the Pd did occur, because the pits require substantial energy expenditure in order to form. This is again consistent with a nuclear source, not chemical.

Second, in addition to helium, it is possible that deuterons might be produced by protium in nickel LANR systems (Swartz 24).

Finally, given the prevalence of the fuel, and the incredible energy production efficiency, LANR is an important revolutionary technology, and will play a critical role in all future technologies with potential revolutionary applications to transportation, electricity production, medicine, and space travel.

### LANR Reactions

In LANR, excess heat and helium-4 are the usual products, but charged particles, tritium, and the sequelae of neutrons can be sometimes detected. In rare conditions, tritium production has been seen (Swartz 13, 3, 4). In India, M. Srinivasan (from BARC) reported tritium in 1989. John Bockris (Texas A&M) reported tritium in bursts but the tritium was not accompanied by measurable heat, which he measured in other experiments. Szpak (SPAWAR) in open cells reported 3000 to 7000 atoms per second for a 24 hour period. Ed Storms (LANL) reported excess tritium in ten percent of his cells.

Most physicists are more aware of the ionization and X-ray production of D+D impact physics without a lattice. In D+D impact physics without a lattice, neutrons and charged particles (fast moving helium ions, alpha particles) are seen.

In hot fusion, the products are fast moving helium [23.8 MeV alpha-particles] which yield 22 keV Pd K shell X-rays and bremsstrahlung below ˜4 keV. Such conventional bremsstrahlung is ionizing penetrating radiation well-associated with hot fusion. In hot fusion without a lattice, the kinetic energy of 23.8 MeV charged particles (alphas) also yields ionizations, Pd knock-off atoms, low energy X-rays, and heat. Secondary neutrons [by D(alpha,n)] have a small cross-section. By contrast, some LANR experiments have detected very low numbers of neutrons and charged particles with short range. Also observed in LANR systems are post LANR mini-explosions, ionizing radiation, and neutron production, and tritium production.

The peak energy of the emissions are consistent with the relatively low energy, but penetrating, ionizing radiation. Miles (China Lake, USN) and M. Srinivasan (Bhabha Atomic Research Center, BARC) independently used dental x-ray films on the outside of his apparatus; they became fogged indicating low energy x-ray production (Swartz 3, 4). M. Srinivasan (BARC) reported neutrons in 1989. As the current increased beyond 100 amperes, neutron signals, in bursts, resulted in six of 11 cells. X. Z. Li (Tsinghua U) first used CR-39 in his 1990 Pd gas loading experiments to detect energetic charged particles [64]. CR-39 is a polyallydiglycol carbonate polymer, widely used as a time-integrating, solid state, nuclear track detector (Swartz 3). Larry Forsley (JWK International) and Mosier-Boss (SPAWAR) have reported D-D and D-T possible reaction pathways capable of generating the observed charged particles, neutrons, etc. Their CR-39 tracks indicate possible neutron interactions, including carbon shattering. Some tracks herald D-D and DT reactions. Etching suggests uniformity in the 2-8 MeV range. The triple tracks, found in ˜5-10 of their experiments, indicate energetic neutrons having shattered a carbon atom.

LANR can occur in one of several different sites within the solid state, deuteron-loaded, metallic palladium lattice. Each location has its own, differing rate of excess heat, tritium, and helium production and appears to be linked to a different group of optimal operating point [OOP] manifolds characterizing active LANR samples and devices (Swartz 13, 15, 20). In addition to optimal operating point control of the desired reactions, empirical system identification control can be used (Swartz 12).

One result is that these observations of significant quantities of high energy charged particles, and emissions, in LANR systems, suggests that there is accumulating, near overwhelming, evidence that nuclear reactions in, and assisted by a lattice, are initiated at low energies (Swartz 10, 11).

### Other LANR Emissions

Newer diagnostics include near- and far-IR imaging which reveal localized hot spots where the desired reactions are producing excess energy. SPAWAR and Swartz have investigated the physical changes, the excess heat generation, hot spots with calibration showing near and far IR emission. Dr. Swartz's and SPAWARS (near- and medical IR imaging) have revealed that in LANR there are cathodic hot spots, and not just Joule heating in the solution (IR drop).

Calibrated imaging has revealed non-thermal near-IR emissions correlated with excess heat (Swartz 9). The calibrated imaging of these localized hot spots, using an infrared camera, reveal non-thermal near-IR emissions correlated with excess heat (Swartz 9) in active LANR devices by in situ monitoring. Swartz discovered the non-thermal IR (NT-NIR) is linked, and specific, to the presence of excess heat production and not their physical temperature. Importantly, this confirms the Swartz-Verner hypothesis that in LANR, unlike hot fusion, Bremsstrahlung emission at significantly lower temperatures, shifts the Bremsstrahlung emissions from high frequency penetrating ionizing radiation toward skin-depth-locked infra-red radiation.

### Types of LANR Systems

Recent devices and methods have involved palladium loaded with deuterons, obtained either from an electrolytic process using heavy water (D₂O) or from the gas phase containing diatomic deuterium (D₂) (Swartz 13, 25, 26).

Others systems involve nickel loaded with protons, obtained either from an electrolytic process using ordinary water (H₂O) or from gas containing diatomic hydrogen (H₂). The desired excess heat has been obtained from Nickel deuterium-loaded systems (also referred to as Ni-D, or NiD) in both aqueous systems (Swartz 17) and nanomaterial components (Swartz 1).

Codeposition LANR systems (Swartz 11, 22) point the way to speedy onset for some of the reactions. Codeposition yields faster results without the prolonged incubation times. In codeposition systems, fresh Pd and D plate out together on the cathode. Highly expanded surfaces, nanoscale spherical nodules dominate on the growing surface. Cyclic voltammetry and galvanostatic pulsing experiments indicate, and excess heat measurements herald, that a high degree of deuterium loading (with an atomic ratio D/Pd>1) is obtained within a very short amount of time.

The results to date indicate nuclear reactions which occur very near the surface of the electrode (within a few atomic layers) but also requiring the bulk lattice. In the original Pd/D codeposition process (confer '976), working and counter electrodes are immersed in a solution of palladium solution with neither chloride nor lithium, deposited on palladium. In the SPAWAR Pd/D codeposition process, working and counter electrodes are immersed in a solution of palladium chloride and lithium chloride in deuterated water, deposited onto silver, gold, or copper. There are specific physical differences in the two types of codeposition involving deep diffusion, where Pd is deposited either on palladium (Swartz 22) or upon non-loading materials such as copper, gold, silver, or platinum (SPAWAR and JWK).

### Theories Involving LANR

LANR is consistent with conventional physics (Swartz 13, 19, 21, 23, 26). The LANR-derived ‘excess energy’ begins (for the Pd-D hydride) with the product obtained containing very high energy, in the excited state of He⁴*. This is obtained from reactions between deuterons within the lattice, and in codeposition also just below the surface.

That helium-4 excited state is either the first excited state, or one energetically located above it, all at least greater than 20 million electron volts (20 to ˜23⁺ MeV) above the ground level. This is significant in magnitude and clearly not “low energy”, as often (mis)claimed. As such purported “low energy nuclear reactions (LENR)” is a misnomer, a paradoxical description of what is actually not observed. Fortunately, they are high energy reactions. This is consistent to what is seen for both hot and cold fusion. This is why we call the desired reactions which produce excess heat: lattice assisted nuclear reactions (LANR).

### The Branching Ratio

In hot fusion, the production ratios of products (branching ratios) are about 50% neutrons with He³, 50% tritium and a proton, and a tiny fraction (less than 1/1,000,000) as nuclear gamma rays. By incredible contrast, the production ratios observed for LANR reactions is mainly He⁴, and negligible He³, neutrons and gammas of very low energies. It turns out that the energies of the states and the lattice explain why. In LANR, the lattice and the nuclear isospin control which products are observed (Swartz 13, 23).

The physics in LANR appears conventional, but the band energies, lattice and isospin issues, and temperature dependences of Bremsstrahlung must be addressed for full understanding.

First, not all emission branches from the excited state of He⁴* are even spin-available. The gamma emission branch from the excited state of He⁴* is actually spin-forbidden for both hot and cold fusion. However, at higher hot fusion temperatures the restriction is slightly lifted.

That is because hot fusion has large activation energies available (it is ‘hot’). By contrast, LANR/CF is not. In LANR, given the actual much smaller amount of thermal energy, k_{B}*T, available for cold fusion (˜ 1/25 eV), absence of adequate activation energy decisively means that that branch is NOT available, as it is for hot fusion. This reaction cannot occur.

Second, the relative absence of neutron and hard gamma-ray penetrating radiation in cold fusion appears to be also due to the lack of availability of adequate temperature for two different, and thermally linked, reasons (Swartz 13, 23).

The first thermally linked reason is that the only nuclear branches available are those whose band gaps are surmountable by the available activation energy (limited by the ambient temperature and incident radiation). The neutron emission branch is more than 1 MeV above the first excited state (He⁴*). This reaction cannot occur.

The second thermally linked reason is that in the analysis for LANR, with the explicit incorporation of temperature into the Bremsstrahlung equations, reveals that ionizing penetrating radiation by Bremsstrahlung is not expected at low (‘cold’) temperature (Swartz 19). The Bremsstrahlung shift (secondary to temperature and lattice availability) alters from what is expected at room temperature with the forward deposition of energy dropping by 18 orders of magnitude. Instead, at cold fusion temperatures, the penetrating ionizing radiation shifts to lower frequencies [to the near infrared (N-IR)] where the radiation is no longer ionizing, and where it is trapped in the palladium by the ‘skin-depth’ effect. In fact, this shift to near-IR was later observed (and reported) in LANR devices when they were operated at their OOP. The result is non-thermal near-IR emission.

### Role of Lattice

It is the lattice that opens up the new pathway in the LANR desired reactions. With LANR systems, it is the lattice which is key to the final products because it controls the de-excitations to produce He4 in the ground state if, and only if, there is coupling though phonons. In LANR/CF, the fast moving He⁴ (as charged particles, alphas) are not seen because the phonons, each about 35-43 millielectron volts, help the ⁴He* state shed ˜20+MeV to return to the He⁴ ground state. However, in a coherent lattice, there are enough phonons to enable transfer in the nanoseconds required—hence the “excess heat”. In hot fusion, the lattice—and therefore the coupling—are not there.

### How the Lattice Enables De-Excitation of ⁴He*

One sine qua non is that there must be enough phonons (lattice vibrations). If they act coherently, and if there are enough vacancies in the lattice or Frenkel defects, then the lattice appears to be “oiled” enough for coherent energy transfer (this is from where the excess heat arises) from the very high energy nuclear state consisting of the nuclear helium excited state to the lattice.

The CAM (catastrophic active media) theory models the unusual change in deuteron solubility that Pd demonstrates with temperature to further explain both the deuteron flux, the phonons, and what drives the deuterons to the vacancies.

The spin boson model, developed by MIT Professor Peter Hagelstein, has led to discoveries of how exchange energy between oscillator quanta enable coherent energy exchange. In that light, demonstrating more utility, another advantage of the present above-entitled invention is its ability to enable visualization of the phonons.

### Role of Loading

The loading is usually driven by an applied electric field intensity (Swartz 10,11,21,26). Originating in the heavy water (D₂O), deuterons first attach to the surface of the palladium cathode, and then many enter (“are loaded”) into the palladium lattice. The deuteron flux begins with a ferroelectric inscription of deuterons in, and through, the aqueous systems (Swartz 18).

To better control these systems, Swartz (Ser. No. 07/339,976, Apr. 18, 1989, a specification pending before the Patent Office) taught the use of a controlled current source rather than a battery. The controlled current source precisely controls the loading of the metal from the electrolytic solution. Insufficient current densities are subthreshold for the desired reactions, and when the voltage becomes too high, then undesirable low dielectric constant layers (large bubble gases) develop in front of the cathode. Both must be avoided for the desired reactions as taught therein.

Once having entered the palladium, the deuteron nucleus is able to dissociate from its electron and freely flow through the metallic palladium crystal lattice. Inside the palladium cathode, solubility isotherms and x-ray spectra demonstrate at least two solid solutions of concentrated protons in palladium. The loaded deuterons residing in shallow energy traps located within, and throughout the lattice, change it in many ways. With increasing deuteron loading—there is a progressive increase in the mass and volume of the sample of said material and the appearance of the desired reactions. To measure loading, Swartz (Ser. No. 09/750,480) uses a vibrational mode of the cathode to measure the loading of hydrogen into the heavier metal based upon the frequency of that vibration decreasing secondary to the increase of mass of the electrode produced by the loading. These desired excess heat producing reactions occur only when the loading achieves the highest filling levels, which happens when there are about as many atoms of deuterons (the isotopic fuel) as there are in the host lattice (e.g. Pd), originally deuteron-free. Thus is it important that there are several crucial electrical and material factors which effect both the loading and the rate of loading (Swartz 8, 13, 14, 20, 25, 26). These include the metallurgy of palladium and the material science of the heavy water solution, including their purity, and the prehistory, and achieved net loading of the palladium lattice to be filled.

At full loading, the deuterons in the loaded palladium provide “a quantum mechanical interaction . . . (over) a long distance” allowing excited nuclei to interact with the lattice, and thus achieve the desired reactions. It is the loaded active lattice which permits the desired reactions.

The bottom line is that the excess heat of the desired reaction, results from de novo helium formation with deuterons as the fuel, and is called “excess enthalpy”. This is the time integral of the excess power gain which is the observed power beyond the input [Pₒᵤₜₚᵤₜ−Pᵢₙₚᵤₜ], for an active loaded palladium cathode. The excess energy is derived in such a system calibrated by an electrical joule control [e.g. ohmic resistor].

The excess energy is defined and derived as Σ[Pₒᵤₜₚᵤₜ−Pᵢₙₚᵤₜ]*Δt.

### Role of Loading Flux

The loading flux of hydrogen, here deuterons into the bulk volume of the palladium cathode, is fundamental to the entire understanding of these phenomena. Simply put, unfortunately not all of the isotopic material of interest enters the metal; D into Pd in the preferred embodiment (Swartz 10,25,26). The application of the power source creates an applied electric field intensity which produces cation flow towards the cathode. There results in the near cathode solution a buildup of deuterons and a low dielectric constant (gas bubble) layer. The electric field distribution is altered as the solution and system each respond with complex conduction and polarization phenomena. Ionic drift, secondary space charge polarization, propagation of solvated deuterons, deuterons in clathrates, and L- and D-deuteron defects with their ferroelectric inscription in the heavy water, and the formation low dielectric constant bubbles abutting the cathode are the minimum expected. The double layer between the solution and the metal is created both by the cathode fall of ions and other polarization reactions.

The problem is that electrical current alone does not, and cannot, reflect the quantity of deuterons entering the palladium lattice (related to the loading flux). A reference electrode in the deuteron solution at equilibrium measures potentials (associated with the Nernst equation), but it, too, gives no information regarding the loading flux rate. Furthermore, during the reactions, the system may not even be at equilibrium.

What can calculate the quantity of entering deuterons is the mathematical Q-1-D analysis where the precise loading flux of deuterons entering into the bulk palladium volume is distinguished from the gas evolving flux [Ser. No. 07/339,976, Swartz (10, 25, 26)].

By contrast to the Nernst equation, the quasi-1-dimensional model of deuteron loading does describe the flux, including the situation external to the cathode.

The quasi-one-dimensional model of loading, based on continuum electromechanics, has led to the discoveries of optimal operating points and the key roles of D-flux, solution conductivity, and cathodic irradiation by laser in LANR systems (Swartz 10. 21, 25m 26). Recently, coupling this with Laplace's law has uncovered the need for deuteron flux within the palladium in an already highly loaded (D/Pd) LANR system.

### The Quasi-1-Dimensional Model of Deuteron Flux and Loading

In the absence of solution convection, molecular flux (J_{D}) results from both diffusion down concentration gradients and electrophoretic drift from an applied electric potential.

$${J}_{D} = - {B}_{D} * \frac{d [ D ( z , t ) ]}{d z} - {μ}_{D} * [ D ( z , t ) ] * \frac{d Φ}{d z} \qquad Eq . 2$$

The equation describes and predicts the distribution of deuteron species in the bulk solution, and describes the result of the cathodic flow of deuterons. These equations are complex because they include the deuteron diffusivity (B_{D}), electrophoretic deuteron mobility (μ_{D}), and have parameters which vary with temperature.

The mathematical solutions are determined both by the boundary conditions and by conservation of mass,

Kₑ=(μ_{D}*E)−(K_{g}+K_{f}) Eq. 3

Kₑ is the rate at which deuterons physically enter the palladium cathode. K_{g} is the rate of deuteron loss to the gas phase (or on the electrode surface) as diatomic deuterium (D₂). K_{f} is the bulk rate of the desired reactions which cause loss of deuterons.

A very important result is heralded by the quasi-1-dimensional analysis of loading and the Einstein relation which indicates that the loading rate is a competing process of loading to gas loss. Gas loss inversely controls loading.

The Q1D model's most important insight is that the first order D-flux equation, with the substitution of the Einstein relation, shows that the ability to load D depends on the ratio of ordering energy, (the applied electric field) to thermal disorder (k_{B}*T) minus what goes up into the gas.

Deuteron availability (secondary to the applied electric field) to the palladium lattice is basically at odds with gas evolution at the cathode. Therefore, the desired reactions are quenched by electrolysis [Swartz(10, 26)].

The loading flux divided by the concentration of deuterons is the first order loading flux rate; for example, kₑ [units of cm/sec].

$${k}_{e} = \frac{{B}_{D} * qV *}{L * [ {k}_{B} * T ]} - ( {κ}_{g} + {κ}_{f} ) \qquad Eq . 4$$

The latter is perhaps most important because it reveals why so many have failed to generate successful LANR, because the name “fusion by electrolysis” is a misnomer. Gas loss inversely controls loading.

The second important result of this analysis is that both competitive gas evolving reactions at the metal electrode surface and the ratio of the applied electric field energy to thermal energy [k_{B}*T] are decisive in controlling the loading flux of the palladium by deuterons.

The third important result obtained from the quasi-1-dimensional analysis of loading is that codeposition offers rapid loading rates [Swartz(22)] using palladium salts located in the solution “and the means to cathodically codeposit said materials directly onto a cathode” for purposes of achieving high local and regional loading.

### Role of Electrical Conductivity on Deuteron Loading Flux

The fourth important result obtained from the quasi-1-dimensional analysis of loading is that assuming a Faradaic efficiency for gas formation of per electron, and accounting for the Faraday, F, then substituting the electrical admittance and electric field intensity, comprised of an electrical conductivity with geometric factors, yields

$${k}_{e} ≅ \frac{{B}_{D} * qV}{L * {k}_{B} T} - \frac{{ξ}_{g} * {σ}_{C} * V}{F * L * [ {D}^{+} ]} \qquad Eq . 5$$

The denominator of the term on the right is the total number of deuterons available times the Faraday. The importance is that the first order loading rate decreases with solution electrical conductivity, which should be kept at a minimum for optimum loading of the palladium (Swartz 8, 10, 16).

### Present High Technology LANR Systems

Swartz (Ser. No. 07/339,976) teaches the importance of the loading the material to high levels, use of a current source, use of controlled current sources, use of a controlled current source to minimize large bubble formation by feedback control, means to control loading rate, means to monitor the desired reaction and report to the user, codeposition of palladium ions from palladium salts within the aqueous solution onto the cathode to increase the efficiency, heat collection, electricity generation, and other features. Specifically, Swartz (Ser. No. 07/339,976) taught a variety of subsystems involving electrochemical loading, heat transfer, energy capture, and irradiation, using novel control components, ports, and select materials, and configurations. Most importantly, this invention includes the important step of loading the material to high levels of loading and activating said isotopic fuel.

Going beyond Swartz (Ser. No. 07/339,976), the invention, tk '342, '143, is, generally speaking, a highly improved version of '976, and is a machine for producing and storing electricity from a hydrogen-loaded material, such as a metal electrode of palladium highly loaded with deuterons, including means for measuring energy released from hydrogen-loaded materials comprising an electrolytic reaction container with a gas-catching hood, a vertical wall, and a positioning extension also comprising two specific locations for the electrodes to separate hydrogen from oxygen as they are generated, in an electrolytic solution of very low electrical conductivity heavy water free of additional electrolytes, monitored by an electrical loading system able to achieve an open circuit voltage greater than 2.4 volts between the electrodes, also comprising a thermal barrier surrounding the reaction container to maintain the desired reactions. It also teaches the means to generate electricity comprising a fuel cell to recombine any generated gases to recover energy and store that energy, followed by a thermoelectric conversion enclosure to produce electricity.

Going beyond Swartz (Ser. No. 07/339,976) and Swartz (Ser. No. 10/646,143), Swartz (Ser. No. 12/154,712) teaches further how to improve deuteron flow within the loaded electrode, and teaches the means to increase intraelectrode hydrogen, or deuteron, flow. The uniquely-shaped spiral Phusor®-type cathodic structure was invented to stand out for reproducibility, high activity, and maximum power gain. Its arrangement and stereo-constellation of electrodes appears to be one of the better arrangements for a LANR system, measured by activity and power gain.

The Phusor®-type LANR device is a metamaterial and its physical structure enhances the metallurgic properties of loaded palladium. This metamaterial change alters the electric field distribution, producing continuous deuteron flux within the loaded palladium. This is unique in all of LANR to this device and it creates a distinguishing electric field (E-field) distribution different from customary wire-wire, and other LANR systems.

### Nanomaterial LANR Systems

Nanostructured materials used in LANR include palladium black, and nanostructured ZrO₂—PdD and ZrO₂-PdNiD powders, such as Zr 67% Ni 29% Pd 4% (by weight before the oxidation step). For simplicity in this specification, all of these nanostructured materials in the core, in their range of deuterations, will henceforth simply be referred to as ZrO₂—PdD or as ZrO₂PdD.

The deuterons are tightly packed (“highly loaded”). The additional D yields apparent indicated loadings (ratio to Pd) of more than 130% D/Pd, although shallow traps have not been ruled out. Most importantly, LANR activated nanocomposite ZrO₂-PdNiD and ZrO₂—PdD CF/LANR quantum electronic components are capable of significant energy gain, and these devices are potentially very useful because they are reproducible (Swartz 2, 6, 7).

Previously, a new generation of such preloaded LANR activated nanocomposite PdD and NiD and PdNidD containing quantum electronic devices capable of energy gain were reported (Swartz 6). For these unique NANOR®-type dry LANR devices, the fuel lies within the nanostructured material, and resides, ready, in the core, and in the preferred embodiment is deuterium (Swartz 7). These devices dry, “glued” into electrically conductive, sealed, configurations have at their core ZrO₂-PdNiD with additional D₂ and H₂. They generate significant excess heat from applied electric fields, and feature two terminals and self-contained superior handling properties enabling portability and transportability.

These components have been carefully evaluated for energy gain, including during, and after, the January, 2012 IAP on LANR at MIT (Swartz 6). One such NANOR®-type preloaded LANR device openly demonstrated clearcut energy gain (COP) which ranged generally from 5 to 16 [e.g. 14.1 (1412%) while the MIT IAP course was ongoing. That calorimeter had parallel diagnostics, such as heat flow measurement, and calibration including an ohmic (thermal) control located next to the NANOR®-type LANR component (Swartz 6).

A typical NANOR®-type component is smaller than 2 centimeters length, with less than 50 milligrams of active LANR material. Although small in size, this is actually not de minimus because the LANR excess power density was more than 19,500 watts/kilogram of nanostructured material (Swartz 2, 6).

Most importantly, the activation of the desired LANR reactions is, for the first time, separated from the loading of the substrate.

### Avalanche Behavior in LANR Nanomaterials

The development of more reproducible nanostructured CF/LANR components has not been easy, and has directly been linked to improved materials, with complete avoidance of low-threshold electrical breakdown states with their CF/LANR quenching tendencies (Swartz 1, 7). They are driven by an electrical circuit and controlled by an electrical driver.

Swartz previously reported sudden changes of, and generally large, electrical resistances of such NANOR®-type devices containing nanostructured materials (Swartz 7, 1). Recently, there was a report of both the observed excess heat on one side of the electrical avalanche and the quenching of that excess heat on the other side (Swartz 1). The loss of excess heat after avalanche saliently demonstrates that outside of the desired LANR active state, the component acts as any other ohmic resistor. Thus, this also confirms that the calorimetry was calibrated, and verifies the excess heat yet an additional way.

### Magnetic Response in LANR Nanomaterials

Magnetically activating these preloaded nanostructured CF/LANR devices is very useful (Swartz 5). Also importantly, there was also an increase in energy gain, and increased incremental power gain, over ordinary LANR. The application of dH/dt created an increase of 4 to 10 times the peak power gain over conventional LANR with the same system. The peak power gain of such treated NANOR®s (M-NANOR®s) ranged from 22 to up to ˜80 times input electrical power or more beyond the control, as determined by calorimetry (Swartz 5).

There are both synchronous and metachronous impacts of a fractionated magnetic field intensity, both associated with strong evidence of two (2) OOP manifolds. Astonishingly, it was discovered that there is also enhanced improvement of LANR (which is synchronous) and there is improved of CF/LANR which is metachronous and longer-lasting (Swartz 5).

In summary, because these LANR devices and their integrated systems can now be fabricated, preloaded, transported, and then activated. These components, and their energy production platforms, are the future of clean, efficient energy production.

### Problems of Present Systems

The LANR method which P-F first taught in March 1989 (hereinafter “F+P”) had problems, including inefficiency, non-reproducibility, and a requirement for very high loading and long incubation time. This created havoc for those inexperienced in metallurgy, electrochemistry, and physics (Swartz 13, 25).

One major problem has been the difficulty in achieving high D/Pd loadings above ˜0.70 near room temperature—and maintaining that for weeks. Simply put, the rapid increase in deuterium chemical potential acts to limit further loading, but success requires high loading of >85% for PdDx hydrides. It also requires control of vacancies, adequate incubation time, concomitant flux, the absence of quenching conditions, and critical control of input power. This was a major problem in early LANR replication because until the early 1990s special effort was not made to achieve high loading required. In most initial efforts, loading was not even considered.

Another important result is that optimum performance of these systems, and many “negative” results of similar systems, are the result of a failure to operate the system at the optimal operating point, which is an optimum peak in the excess heat and power gain curves as a function of input electrical power [(Swartz 13, 20, 21)]. The optimal operating point reflects the relatively narrow peak (maximum) of the biphasic production rate curve for the products obtained by the desired reactions (heat, helium-4) as a function of input electrical power.

Driving with electrical input power beyond the peak optimal operating point does not improve the production of the desired product but instead yields an underdesireable falloff of the production rate with increasing input power. Thus, the failure to operate similar systems at the optimal operating point (OOP), because of driving the systems inadvertently or unintentionally beyond the optimal operating point, accounts for some of the widespread difficulties in observing the desired reactions. The problems with loading, and later with optimal operating point manifolds (OOPS) are why initial efforts to replicate successful LANR were so difficult.

LANR success is rewarded by “excess heat”, which means that the energy producing reactions, have generated de novo helium into the lattice, (˜10¹² for every watt-second), and those conditions were adequate to enable energy transfer to the lattice (Swartz 10, 18). Patterns of failure, and means to avoid both false positives and negatives, have been previously discussed in detail elsewhere [Swartz (13, 20)].

In summary, most other previous efforts failed because of flawed paradigms, cracked inactive palladium cathodes, contamination (including from ordinary water), and most often, improper cell configurations, inadequate loadings, and incubation times. The additional keys for LANR are that there must be integrity of the loaded alloy; a condition difficult to achieve, although it is circumvented to some degree by the codeposition methods, albeit with their limitations. As the lattice loads, it swells. Too much swelling yields irreversible failure, just like a swollen, burst, balloon. Another requirement is that deuteron flux must continue, within and through the already highly loaded lattice.

### Advantages and Qualities of the Present Invention

The invention described by the above-entitled application has many advantages over present devices, processes, and systems. It is a significant improvement over all’ previous technologies. The following advantages are discussed without demeaning any of the others.

One object of the invention is to avoid or minimize undesired reactions, thereby of great utility. This invention could be used to control the generation of products, and those products could be heat, and could be new materials, or related to improved lubrication, flow, fuel use, and propulsion. Because this invention could be used to control the generation of products, it therefore has relevance to energy production, energy storage, and energy utilization of hydrogen-loaded and deuterium-loaded metals and other materials. These could be involved in control of materials or energy transfer, including to an electric grid and for other useful purposes including transportation, or making new materials, or mitigating radioactivity.

In previous hydrogen-loaded systems to produce excess heat beyond the electrical input, there has been limited reproducibility, and few have achieved peak performance from the loaded metals, and none have visualized and controlled the state of material which may be used to generate products. Accordingly, it is another principal object of the present invention to provide detection and identification of the desired states, and to enable better control and thus maximize the desired generated heat which can then be used to produce electricity from such loaded metal systems.

Previous systems have been limited in obtaining in situ measurements and reaction visualization including the absence of any which might predict future heat generation and/or material production or breakdown. Accordingly, it is another principal object of the present invention to illuminate, visualize, and to detect the intermediaries, products, and the desired, and undesired, reactions.

Previous technologies involving heat released from metals loaded with an isotope of hydrogen have been inefficient because in addition to the desired state being difficult-to-achieve, it has been unclear what state they are in, even while being electrically driven. Accordingly, it is a further object of the present invention to provide a novel solution to the problem of detecting the desired state of such systems including loaded metals, and of controlling their peak performance.

The invention described by the above-entitled application thus solves the problem of permitting easy, real time, visualization of the requisite state of the material as to both the desired reactions and undesired states, features of great utility.

The present invention can also be used to identify the reaction state of material. This state might involve its generation of product, or might relate to changes within that material, itself, such as generating phonon gain. In accordance with the teachings herein, improved visualization of the undesired reactions can be achieved.

In previous hydrogen-loaded systems to produce excess heat beyond the electrical input, there has only been the heat generated to use as a marker in an attempt to achieve peak performance. In accordance with a further aspect of the invention, and of great utility, means are provided to solve the problem of improving the performance of heat-releasing metals even before said heat is released and measurable, thereby maximizing the generated heat from such hydrogen loaded metals.

Previous systems have not been able to detect directly phonons in hydrogen loaded systems, but have been inferred indirectly through beat frequency two wavelength systems (Hagelstein, P. L., D. Letts, D. Cravens, “Progress on two-laser experiments”, Proc. ICCF15 (2009); http://lenr-canr.org/acrobat/Hagelsteinprogresson.pdf). In accordance with the teachings herein, the present invention is also concerned with direct observation of the phonons, and can illuminate the presence phonon gain.

Furthermore, in accordance with the teachings herein, the present invention solves the problem of controlling energy production, by visualizing and reacting to the actual states of the hydrogen loaded material being driving, including the desired requisite phonon gain which is a sine qua non to the desired reactions.

Previous systems have not fully convinced educators, scientists, and students, of the importance of hydrogen loaded systems. In accordance with the teachings herein, the present invention also enables human control of the desired reactions from hydrogen loaded systems, and thus directly solves the problem of educating students and scientists regarding the control of generated heat from hydrogen loaded metals. Specifically, it has additional use as an educational tool for teaching both how visualization of states can be used to control the magnitude of selected states of a material, including those produced from hydrogen-loaded materials compared to other systems.

Successful LANR can resolve the energy problem, and it impacts the availability of fresh water and human health. It is a real solution to the pollution and climate change issues the world is devastated by today. Thus, the above-entitled invention mitigates the finite availability of oil, and improves the generation of energy from hydrogen loaded metals and alloys. This is of incredible, if not the utmost, utility.

### BRIEF SUMMARY OF THE PRESENT INVENTION

In accordance with a preferred embodiment of the invention, there is disclosed a machine for observing phonon gain to control desired reactions of an electrically driven hydrogen loaded material comprising: a container with at least two optical ports containing a sample of said material, a power supply and wiring connections to enable driving a sample to be examined, a power supply to drive at least two lasers, a controller to regulate the output of said lasers, a beam path to enable illumination of the sample, a controller to regulate control of electric power delivered to said sample enabling driving in more than one state, a detector system to examine the backscatter radiation from the sample which is illuminated, a second beam path to enable said backscatter to reach said detector system, a computation system to separate the frequencies of said backscatter and to determine the intensities and distribution of said backscatter, and a second computation system to compare the desired intensities and distribution of said backscatter and to compare that to what was detected and to derive changes as necessary for said power supply which enables driving and controlling said hydrogen loaded material.

### BRIEF DESCRIPTION OF THE SEVERAL VIEWS OF THE DRAWING

Turning now to the figures. In accordance with the teachings of the present invention,

FIG. 1 shows a schematic block diagram of the above entitled invention which lists the subunits, and significant control points of light, energy, information and electrical flow.

FIG. 2 is a graph with several curves showing results of one reproducible nanostructured two-terminal electrical component driven in two different electrical states, and in its ‘off’ state, and with an electrical ohmic control.

FIG. 3 is a curve which shows the response of the invention to the raw material, ZrO2PdD, which has been inserted into a transparent cylinder, with no additional electrical activation.

FIG. 4 is a curve which shows the response of the invention to an electrically driven and activated material ZrO2PdD, which has been inserted into a transparent cylinder.

FIG. 5 is a curve which shows the response of the invention to an electrically driven and activated material ZrO2PdD, which has been inserted into a transparent cylinder, and which most importantly is in it's optimal desired state, where large amounts of energy, termed ‘excess energy, is being released.

FIG. 6 is a curve which shows the response of the invention to an electrically driven and activated material ZrO2PdD, which has been inserted into a transparent cylinder, and is in it's optimal desired state, but now there is a logarithmic vertical axis which enables other peaks of less intensity to stand out.

FIG. 7 is a graph which shows several curves showing different responses of the ZrO2PdD-filled nanomaterial NANOR®-type CF/LANR component in several states; the electrically driven state, that is “off”, in avalanche mode, and in the optimal desired state where large amounts of energy are being released.

FIG. 8 is a curve which shows the response of the invention to the material ZrO2PdD and the simultaneous application of an applied magnetic field of an intensity circa 3 Tesla.

FIG. 9 is a histogram is shown that summarizes some of the important results discovered by the above entitled invention used to examine the two terminal NANOR®-type CF/LANR component with several materials and several drive states. Also shown is the expected Boltzmann statistic ratio that depends on frequency and the temperature.

FIG. 10 is a curve which shows the response of the invention to canola oil held in plastic, which itself was then inserted into the sample container which makes visible the reason why canola oil is so appreciated in 3D printing.

### DETAILED DESCRIPTION OF THE PRESENT INVENTION

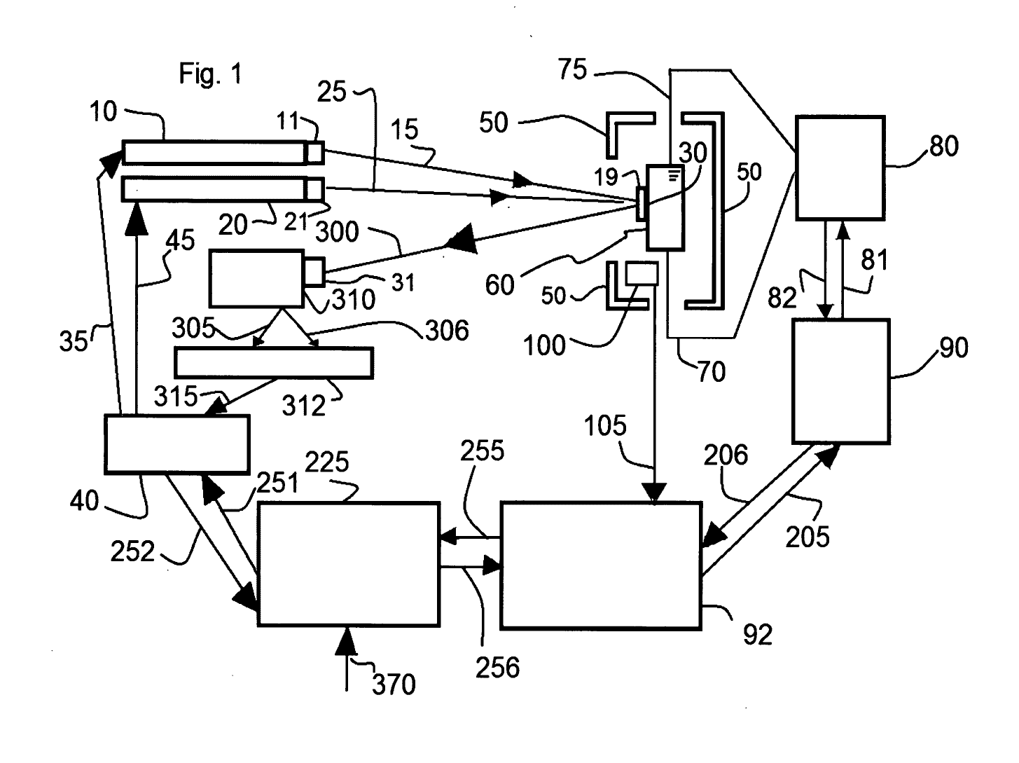

The detailed summary will now be explained through the claims, and figures and original specification. Turning now to the figures. In accordance with the teachings of the present invention, FIG. 1 shows a schematic block diagram of the above entitled invention which lists the subunits, and significant control points of light, energy, information and electrical flow. Shown are two lasers (labeled number 10 and number 20) which are capable of illuminating a target (labeled 30) which is located on the surface of a sample of interest (labeled 60).

The lasers produce two optical beams of coherent radiation (labeled 15 and 25). Optics for collimation, beam direction, band pass, and the like are shown, and labeled as 11 and 21. Those two optical beams overlap, and as a control do not, at the sample's surface, at a chosen target location (labeled 30) and, at a location where thereafter they interact with said sample (60). A geometric lens, and the like, (labeled 19) optionally can be placed just above the beams interaction with said sample. It is not always required, but is quartz in the preferred embodiment. Alternatively, it could be glass, plastic, or another material like germanium.

In the Figure (FIG. 1), the container is shown in three parts, but actually is one single container (labeled 50). At the interaction surface and nearby volume of said sample (labeled 30), the beams interact with the sample, and are reflected as a single optical beam (labeled 300) after said interaction with the sample. The important result is that there become more than the two frequencies which began, coming from the two lasers. There may be photons of energy both above and below the two frequencies of said lasers.

The exit beam (labeled 300) is thereafter, following transit through an optical slit (labeled 31) and a diffraction grating (labeled 310), where it is resolved into different frequencies (or in equivalent systems into wavelength distances, or energies).

It is important to note that alternatively, instead of frequency, either energy or wavelength can be used since they are interconvertable, from the equation

ν*λ=c Eq. 6

where ν is frequency, λ, is wavelength and c is the speed of light.

This separation by frequency (energy, or wavelength) is shown symbolically in FIG. 1, and is labeled by the range extending from 305 to 306. It is measured by a detector such as a CCD in the preferred embodiment (labeled 312).

In the preferred embodiment said optical diffraction grating is a holographic (or hologram) type, and other types exist including those which are blazed. Alternatively the separation of frequencies (or alternatively energies or wavelengths, see below) can be achieved by a monochrometer, or a prism, and the like.

Alternatively, the detector can be a photographic plate, or android telephone, or I-phone, or other such system which detects the separation of frequencies by recording the intensity at each physical location. A RAW image format should ideally be used for improved linearity.

This central analytic unit (40) receives the incoming detected optical information which has been sorted by the grating (labeled 310) and counted by the detector (labeled 312). The central analytic unit thus enables examination of the optical peaks of the received beam (labeled 300) so as to not just determine the total energy but also to derive the reflected beams' amplitude and intensity sorted by frequency.

To enable optical feedback control in the system, the central optical analytic unit (labeled 40) feedback controls the lasers through two cables (labeled 35 and 45).

To enable electrical drive feedback control in the system, the central analytic unit (40) also sends the derived optical information, including the ratio of peak amplitudes, to a microprocessor (labeled to 225) through a cable which is labeled number 252. There is also feedback from said microprocessor to the central analytic unit through the same cable (labeled 252).

The sample (60) is, or may optionally be, electrical driven, while it is irradiated by the two lasers as it is physically located in a container (labeled 50) which is capable of accepting and not electrically shorting two electrical wires (labeled 75 and 70) from the electrical drive, even as it is also capable of transmitting the two incoming optical beams from the lasers (labeled 15 and 25) and the exit beam (labeled 300). The sample (labeled 60), held in the container labeled 50 and illuminated at the region labeled 30, is electrically driven by an electrical power supply (labeled 80).

The electrical power supply (labeled 80) connects to the sample through an anode wire (labeled 75) and a cathode wire (labeled 70).

The electrical power supply is capable of delivering an electric current (Norton equivalent) or electric voltage (Thevenin equivalent) through the two wires which connect to the sample (labeled 75 and 70).

The electrical power supply (labeled 80) therefore has several electrical states, the simplest of which are “off”, meaning that the sample is not electrically driven by the electrical power supply (labeled 80), and “on” where there may be a range of electrical driving levels of electrical power (watts).

Within the container (50), in the preferred embodiment, there is a temperature detector, and a heat flow detector (labeled 100). The temperature and/or heat flow detector (100) is connected (labeled 105) to, and thus linked, to a temperature measurement and analytic unit (labeled 92).

This enables thermometry, and in the preferred embodiment calorimetry, of said sample and is therefore used to enable feedback control as well as measure any possible incremental heat output from said sample (60), itself.

Output from the temperature measurement and analytic unit (92) exits to the power supply control unit (labeled 90) through a cable connection (labeled 205; and the information return labeled as 206). The power supply control unit (labeled 90) controls, through a cable connection (labeled 81), the electric power supply (80).

The driving information goes in two directions from the power supply, back to the power supply control unit through another control cable (labeled 82).

Output from the temperature measurement and analytic unit (92) also exits to microprocessor control unit (labeled 255). Note that there is feedback information and control to the temperature measurement and analytic unit (92) through a cable connection (labeled 256).

The microprocessor (225), then with the incoming data and information, is able to compute, based upon that information and the ratios of peak amplitudes, exactly what has been obtained from the optical interrogation of said sample (30), and what electrical power (and energy) have been delivered to the sample, and said sample's incremental temperature (and in the preferred embodiment, also calorimetric) response.

Although a microprocessor is used in the preferred embodiment, a microcomputer, or other method of algorithmic change, can make all derivations which can also be used, with the same calculations achieved and done, for the required feedback.

Then, based upon the user input (labeled 370), the microprocessor (210) is able to alter the analytic unit through cable 251 and is able to alter the controller of the electrical power supply driving the sample (labeled 90) through its control of said electric power supply (80).

Although this is a description with the invention as an apparatus, an equivalent system can be fashioned using the teaching of the above-entitled invention as a process. In that case, FIG. 1 shows a method for detecting phonon gain in a material. It does this by positioning a container with at least two optical ports and at least two electrical ports in the preferred embodiment. Alternatively, an arrangement can be made for a larger or smaller number of such ports, but combining both input and output to a single port, and by combining the electrical and optical ports, or by adding additional ones for other activation systems.

In this process, the next step is providing a sample capable of at least one desired reaction, and driving that reaction by enabling an electrical power supply using wiring connections made to enable driving of the sample to be examined.

In the process, in the preferred embodiment, the sample is examined after powering at least two lasers while controlling the output of the lasers which are then arranged for illuminating the sample using the lasers. In the preferred embodiment, arrangement is made to examine both overlap the optical beams as well as using an off-sample separation as a control,

The sample is driven initially by regulating the control of the electric power supply to drive the sample into the desired reaction state. However, this may, or may not, be achieved, and therefore examination is further made by detecting and examining the backscatter radiation from the sample undergoing the above taught illumination and control and drive systems. By separating the frequencies of the backscatter, means are made to determine both the intensities and distribution of the backscatter as a function of frequency. In the preferred embodiment, frequency is used, but alternatively this could be by energy or wavelength as discussed further below. Finally, the process of the above-entitled invention continues by comparing the desired intensities and distribution of the backscatter to what is expected for the said desired reaction. If there is any deviation from what is desired, the final step of the process involves deriving the changes necessary to alter control of the power supply which then enables driving the sample in the desired reaction state.

The different electrical states of a single electrical component are now shown, and are important, because successful development of this heat producing component has been directly been linked to improved materials and complete avoidance of low-threshold electrical breakdown states where there is much less heat wrought; that is, with the electrical avalanche, the desired excessive (or excess, compared to the electrical input) heat expected to be produced is quenched (Swartz 2, 7).

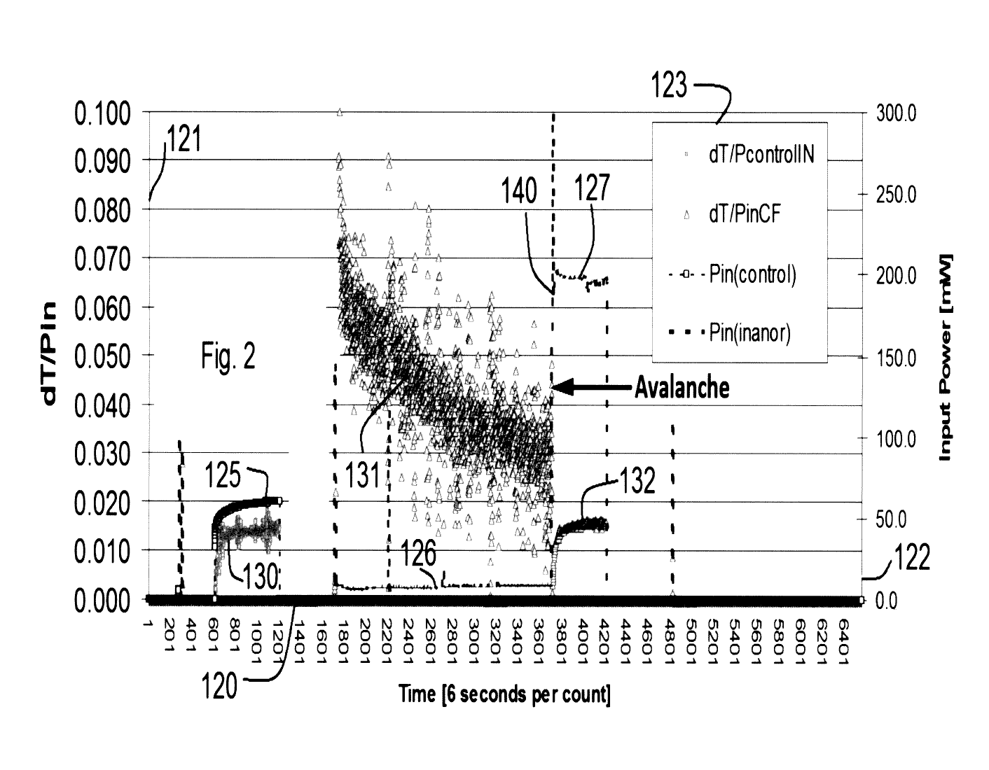

Turning now to FIG. 2. FIG. 2 is a graph of one reproducible nanostructured two-terminal electrical component driven in two different electrical states, and in its ‘off’ state, and with an electrical ohmic control.

A horizontal axis (labeled 120) plots the electrical input power (labeled 122), and the heat generated (labeled 121), as a function of time.

FIG. 2 shows the measured heat production from the nanostructured two-terminal NANOR®-type LANR component on both sides of the electrical breakdown (avalanche) state. This transformation of active CF/LANR components from active to inactive states is critical to successfully control the desired reactions, and to maximize output, and to avoid damage to some nanomaterials.

For three of the six curves shown (labeled 125, and 126), the second vertical axis, on the right hand side (labeled 122), represents the electrical input power to the ohmic control (125) and to the two-terminal nanostructure component before electrical avalanche (126), and to the two-terminal nanostructure component after electrical avalanche (127).

The first curve, extending from count circa 601 to 1201 (where each count is 6 seconds) is for the ohmic control (labeled 125). The second curve, extending from count circa 1701 to 3701 (where each count is 6 seconds) is for two-terminal nanostructure component (126). The electrical input is slowly increased to both the ohmic control and to the component, while each is activated, respectively. However, only the two-terminal nanostructure component at about 3701 suddenly undergoes paroxysmal electrical avalanche so that there is much, much more electrical input power (labeled 127), as shown in the third curve. This third curve, also for two-terminal nanostructure component (126), lasts until about count 4201 when the input electrical power is turned off.

For the next three of the six curves shown (labeled 130, 131, and 132), the first vertical axis, on the left hand side, represents the heat generated through the parameter dT/Pin which is the change in temperature elicited divided by the electrical input power. FIG. 2's second of three curves plots the temperature rise [delta-T in degrees C.] of the ohmic control and the NANOR®-type LANR component, both normalized to input electrical power as a function of time so that the ratios can be used to estimate incremental power gain.

The first dT/Pin curve, extending from count circa 601 to 1201 (where each count is 6 seconds) is for the ohmic control (labeled 130). The second curve, extending from count circa 1701 to 3701 (where each count is 6 seconds) is for two-terminal nanostructured component before electrical avalanche (131), and for the two-terminal nanostructured component after electrical avalanche (132).

By comparing, 131 to 130, and then 132 to 130, by ratio, a qualitative to semiquantitative estimate of the incremental power gain can be derived, both before electrical avalanche (from the first pair) and after electrical avalanche (from the second pair).

Thus, there is obvious incremental power gain for the CF/LANR component until the avalanche, at which time (count ˜3700) the component has no energy gain, but has a response similar to an ohmic resistor. This saliently demonstrates that outside of the desired heat-producing CF/LANR active state, the nanostructured component acts as any other ohmic resistor. It also, not insignificantly, thus confirms that the calorimetry was calibrated, and verifies the accurate presence of excess heat yet an additional way. This result also demonstrates significant excess heat obtained from a Ni-D nanomaterial system, as reported previously in a high impedance aqueous CF/LANR system (Swartz 13, 17).

In the preferred embodiment, the central core generating the excess heat in the desired state involves a member of the group consisting of PdD, NiD, NiPdD, ZrO₂PdNiD, ZrO₂PdD, ZrO₂NiD, or ZrO₂NiH (alternatively written as ZrO₂-PdNiD, ZrO₂-PdD ZrO₂-NiD, or ZrO₂—NiH) and similar materials as discussed in Swartz (2, 7, 13).

These NANOR®-type devices have been described in the literature (Swartz 1,2,3,4,6,7).

By way of further background, as described in a series of peer-reviewed publications (Swartz 1, 2, 7), certain materials of this nature when examined electrically have distinct electrical behavior, with distinct outputs in each of the state's electrical driving states. To simplify, in addition to the “off” state, there are “avalanche” state which is undesirable, and a series of desired states which produced substantial amounts of heat, even when even high applied voltages yield lower electrical currents going through said raw material. These “desired” states, which produce very large amounts of heat, are electrically and behaviorally therefore quite different from the “undesired avalanche” state.

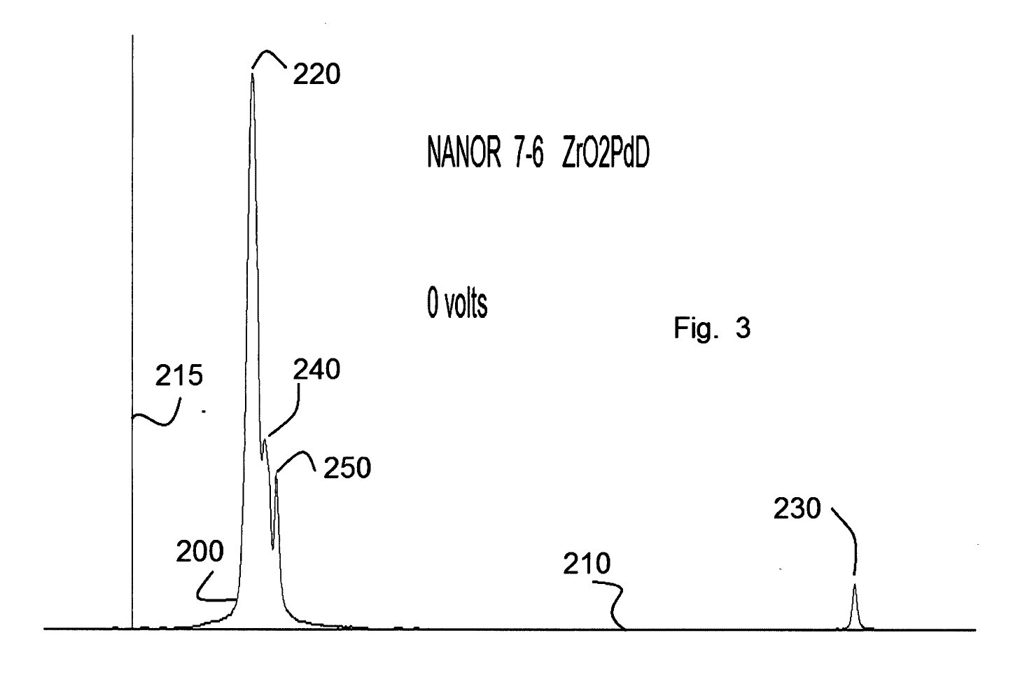

Turning to FIG. 3. This Figure, number 3, by way of graphical figure shows the response of the invention to the raw material, ZrO2PdD, which has been inserted into a transparent cylinder, which itself was then inserted into the sample container, labeled 50, as shown in FIG. 1.

There is no additional electrical activation (as will be seen in some of the following figures). The results of the illumination of said raw material, in said cylinder, in said container, by the two lasers, and collection of data, as schematically shown in FIG. 1, is shown in FIG. 3.

In FIG. 3, the response of a two terminal electrical component filled with the nanomaterial ZrO2PdD is shown.

Curve 200 in FIG. 3 specifically shows the observed optical output in the component's off “state” as observed by the above-entitled invention.

A horizontal axis (labeled 210) plots the decreasing frequency to the right. It also plots, therefore, increasing wavelength. In the curve shown (200), the vertical axis (labeled 215) represents the intensity returned by backscatter along the reflected optical beam (labeled 300 in FIG. 1).

In FIG. 3, the output of the first laser is shown with a peak at 532 nm, labeled in FIG. 3 as 220. The output of the second laser is also shown in FIG. 3, with the peak labeled 230.

One important aspect of the invention is that it reveals that there are additional peaks, which are shown labeled 240 and 250. In this enhanced scatter by this invention, the larger peak labeled 220, is a Rayleigh scattering peak. The peaks labeled 240 and 250 are what could be called Stokes-shifted peaks.

Stokes-shifted peaks are at lower energy (lower frequency which is also longer wavelength). AntiStokes-shifted peaks are at higher energy (higher frequency which is also shorter wavelength).

When such peaks involve a lattice and acoustic phonons they are called Brillouin peaks. When they involve molecular rotation and the like, they are called Raman peaks.

In the above-entitled invention, one important difference from Brillouin and Raman spectroscopy, is that these peaks are exceptionally high. Furthermore, other techniques only identify materials, while here the present invention reveals the electrical state of the component and has the means to electrically drive and control and monitor that component and state, as desired.

For analysis, what is often done is to take the ratio of the Intensity of the antiStokes peaks to the intensity of the Stokes peaks. Here, this ratio is called the Boltzmann Analysis ratio. It is also known as the Boltzmann factor.

It is normally equal to the exponential of the ratio of two energies. Those energies are the energy of the difference in energies and the thermal energy (which is the Boltzmann constant times the thermodynamic temperature in degrees Kelvin).

This ratio of Intensities reflects the Boltzmann distribution computed for two such states, such as the intensity of the antiStokes peak to the intensity of the Stokes peak. Thus the Boltzmann Analysis ratio is the following equation.

Intensity(antiStokes)/Intensity(Stokes)=exp(−E_{diff}/(kB*T)) Eq. 7

where E_{diff} is the energy difference between the two states and kB is the Boltzmann's constant.

The present invention reveals that not all LANR nanomaterial states and drive regimes are the same, nor are they alike, like other materials.

Specifically, as noted here there is not the expected amount of antiStokes peaks, which would be to the left of the largest peak, labelled 220. This difference, ie the loss of the ratio of Intensity(antiStokes)/Intensity(Stokes) is what is observed in the “off” state for these nanomaterials.

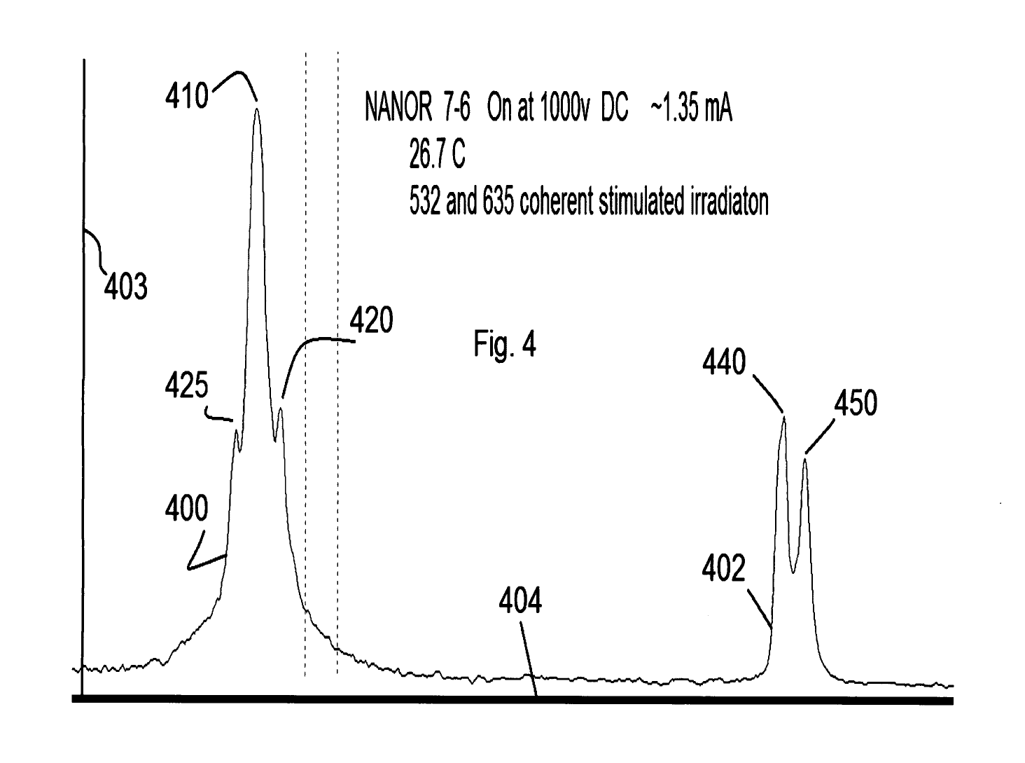

Turning to FIG. 4. This Figure, by way of graphical diagram, shows the response of the invention to an electrically driven and activated material ZrO2PdD, which has been inserted into a transparent cylinder, which itself was then inserted into the sample container, labeled 50, as shown in FIG. 1.

In FIG. 4, the response of the filled component, which is a two terminal NANOR®-type LANR electrical component, filled with the nanomaterial ZrO2PdD, in avalanche mode is shown. For FIG. 4, this nanomaterial component was electrically driven at 1000 volts initially (direct current) which produced about 1.35 milliamperes. Thereafter, the voltage decreased with time. The ambient temperature was 26.7° C. This behavior is what is termed “avalanche mode” and usually results from excessive applied voltage. As described in said series of peer-reviewed publications (Swartz 1,2,6,7), certain materials of this nature when examined electrically have distinct electrical behavior, with distinct outputs, with as shown here an electrical “avalanche” state, which is usually undesirable. The avalanche state is associated with increasing electrical current at falling required electrical potentials.

Curve 400 in FIG. 4 specifically shows the observed optical output in the avalanche “state” as observed by the above-entitled invention. A horizontal axis (labeled 404) plots the decreasing frequency to the right. It also plots, therefore, increasing wavelength. In the curve shown (400), the vertical axis (labeled 403) represents the intensity returned by backscatter along the reflected optical beam (labeled 300 in FIG. 1). Dual laser coherent stimulation was used. The laser irradiation at 532 nm is of a power level on the order of 150 milliwatts while the laser irradiation at 635 nanometers is circa two milliwatts. As such, coupled coherent stimulated transfer responses can occur.

Curve 400 reveals two groups of peaks; the first characterized by the largest peak at 532 nm, labeled 410. The importance of these two groups of peaks can be seen in this FIG. 4.

In FIG. 4, the peak of the first laser (10 in FIG. 1) is shown with a peak at 532 nm, labeled in Figure as 410. It can be seen that just to the right of the largest peak (labeled 410) is a smaller peak (labeled 420). This peak is almost balanced by a second, slightly smaller, peak (labeled 425) on the opposite side of the largest peak (labeled 415). What is seen to the left of the first peak is termed an antiStokes peak (labeled 425 nanometers).

There is a second group of smaller peaks (labeled 402) where the peak labeled 440 is at 635 nm, and came from initially the orange laser (second laser 20 in FIG. 1). The output of the second laser is also shown in FIG. 3, with the peak labeled 440. In addition, on the right of the peak at 635 nanometers, is a second peak, also slightly smaller (labeled 450).

In this enhanced scatter by this invention, the larger peak labeled 410, is a Rayleigh scattering peak. The peaks labeled 420 and 425 are what could be called Stokes-shifted peaks.

There are many important things that accrue from the above-entitled invention. First, by use of the second group of laser peak(s), semiquantitative calibration can occur. Second, another important aspect of the invention is that it reveals that there are additional peaks, including those which are saliently shown labeled 420, 425, and 450. Third, it can be seen that there is a Stokes-like shift for both the coherence stimulated radiation at 532 nm, and at 635 nm. This indicates that these shifts are quite real because they occur at both incident frequencies.

Importantly, fourth, as noted here, there is, in this avalanche mode for the two-terminal NANOR®-type CF/LANR component, close to the near-expected amount of antiStokes peaks. It is higher in amplitude than expected for an initial Boltzmann Statistic calculation, in part because the temperature is increased in the sample, and to a lesser degree due to curve shift to a very slight amount. The augment the contribution of the avalanche mode in the LANR nanomaterial.

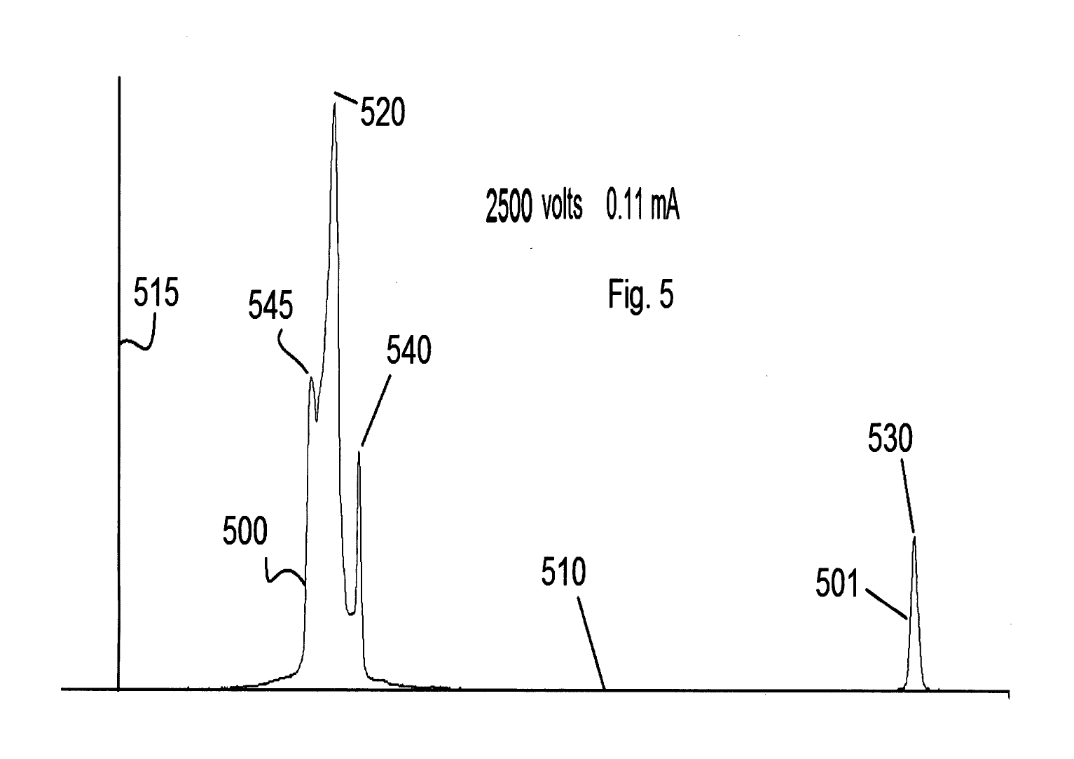

Turning to FIG. 5, curve 500 also reveals the results of the above entitled invention when used to examine this nanomaterial NANOR®-type CF/LANR component, and most importantly when it is in it's optimal desired state, where large amounts of energy, termed ‘excess energy, is being released.

In FIG. 5, the response of the filled component, which is a two terminal electrical component, filled with the nanomaterial ZrO2PdD the best, most preferred, heat producing mode is shown. As described in a series of peer-reviewed publications (Swartz 1, 2, 6, 7), certain nanomaterials of this nature when examined electrically have distinct electrical behaviour, with distinct outputs, with as shown here—and discussed in other of literature—an electrical “desired” state, which is characterized by reactions such as heat generation or nuclear transmutation, such as the formation of de novo ⁴He.

In this case, the so-called “desired state”, there is a large a very much larger-than-expected antiStokes peak (labeled 545).

This Figure, number 5, by way of graphical figure shows the response of the invention to the correct electrical activated material ZrO2PdD, which has been inserted into a transparent cylinder, which itself was then inserted into the sample container, labeled 50, as shown in FIG. 1.

For FIG. 5, this nanomaterial component was electrically driven at 2500 volts which produced about 0.11 milliamperes and maintained its high impedance during the very short run. This is what is termed “desired mode” and only results from proper drive voltage, maintaining high impedance, avoiding quenching materials and quenching states, as discussed in Applicant's other patent applications (Swartz 1, 2, 6, 7,11, 13, 14).

In FIG. 5, the response of the filled component, which is a two terminal electrical component, filled with the nanomaterial ZrO2PdD in the desired mode is shown. Curve 500 in FIG. 5 specifically shows the observed optical output in said desired state, as observed by the above-entitled invention.

A horizontal axis (labeled 510) plots the decreasing frequency to the right. It also plots, therefore, increasing wavelength. In the curve shown (500), the vertical axis (labeled 515) represents the intensity returned by backscatter along the reflected optical beam (labeled 300 in FIG. 1).

Dual laser coherent stimulation was used. Curve 500 reveals two groups of peaks; the first characterized by the largest peak at 532 nm, labeled 520.

There are many important things that accrue from the above-entitled invention. First, by use of the second group of laser peak(s), semiquantitative calibration can occur. In FIG. 5, the peak of the first laser (10 in FIG. 1) is shown with a peak at 532 nm, labeled in FIG. 5 as 520. The output of the second laser (20 in FIG. 1). is also shown in FIG. 5, in the section of curve labeled 501, with the peak labeled 530.

Second, another important aspect of the invention is that it reveals that there are additional peaks, including those which are saliently shown labeled 540 and 545.

In FIG. 5, the peak of the first laser (with a peak at 532 nm, is labeled as 520. In this volume enhanced dual laser backscatter invention, the largest peak, labeled 520, is a Rayleigh scattering peak. The peaks labeled 540 and 545 are what could be called Stokes-shifted and antiStokes-shifted peaks.

Third, importantly, in this desired high electrical impedance state, high heat mode for the two-terminal NANOR®-type CF/LANR component, there is, more than the expected amount of antiStokes peaks.

It can be seen that just to the right of the largest peak (labeled 520) is a smaller peak (labeled 540). This peak is more than by a second, slightly larger, peak (labeled 545) on the opposite side of the largest peak (labeled 520). What is seen to the left of the first peak is termed an antiStokes peak (labeled 545).

It is much higher in amplitude than expected for an initial Boltzmann Statistic calculation, beyond any known calculated temperature, and beyond what could accrue due to curve shift to a very slight amount.

Fourth, it is discovered that in the excess heat mode of this component that phonon gain can be visualized, documented, measured and used. This new appeared phonon gain is direct Evidence of a new state. It corroborates the indirect Evidence of Cravens, Letts, and Hagelstein (“Progress on two-laser experiments”, Proc. ICCF15 (2009); http://lenr-canr.org/acrobat/Hagelsteinprogresson.pdf).

As Gayle Verner has stated, “LANR and cold fusion have been treated as a ‘ghost’ and (the above-entitled invention) enables the ‘ghost’ to be seen”.

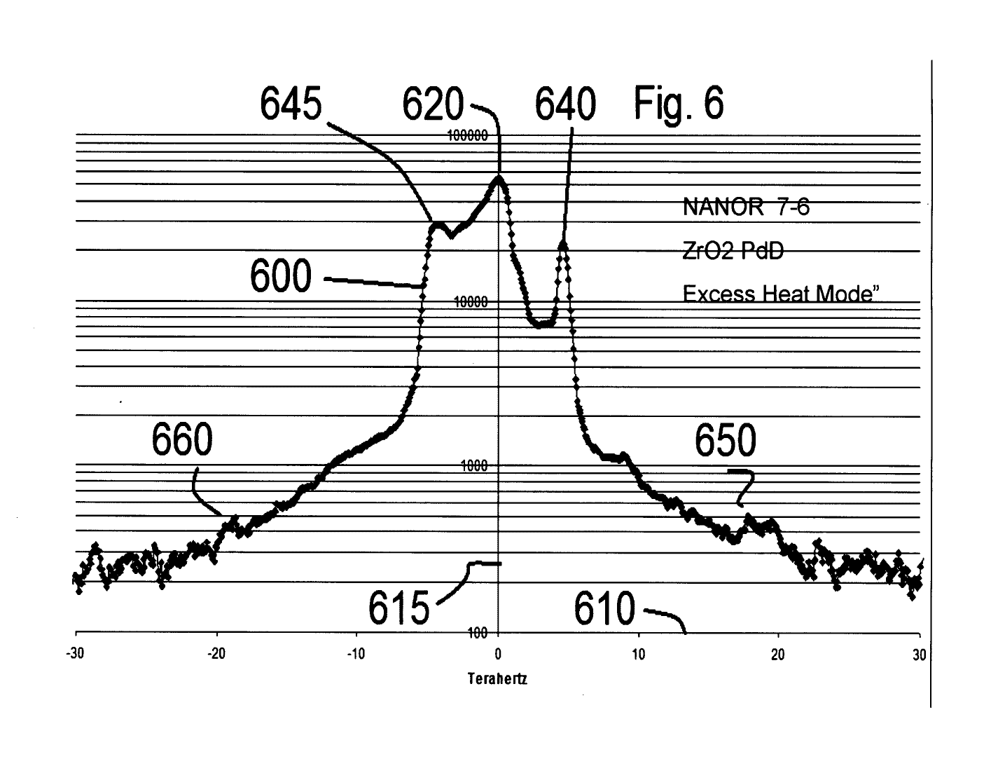

Turning to FIG. 6, the previous curve 500 from FIG. 4 is redrawn in FIG. 6 as curve 600 plotted in this figure, but now on a logarithmic vertical axis. This will enable other peaks of less intensity to stand out.

For FIG. 6, this nanomaterial component was electrically driven at 2500 volts which produced about 0.11 milliamperes and maintained its high impedance during the very short run. This is what is termed “desired mode” and only results from proper drive voltage, maintaining high impedance, avoiding quenching materials and quenching states. Dual laser coherent stimulation was used. The excess power gain was in the range of 50 to 100 or greater.

Thus, in the curve shown (labeled 600), the vertical axis represents the logarithm of the intensity returned by backscatter along the reflected optical beam (labeled 300 in FIG. 1), with the sample (60 in FIG. 1; present as an electrical activated material ZrO2PdD, which has been inserted into a transparent cylinder, which itself was then inserted into the sample container, labeled 50 as shown in FIG. 1) in the “desired” heat producing state, as observed by the above-entitled invention. A horizontal axis (labeled 610) plots the decreasing frequency to the right. It also plots, therefore, increasing wavelength.

In FIG. 6, curve 600 again reveals the results of the above entitled invention when used to examine this nanomaterial component, while it is electrically driven in it's optimal desired state, where large amounts of excess energy, through continuous excess power gain, are being released.

In FIG. 6, the peak of the first laser (10) is shown with a peak at 532 nm, labeled in FIG. 6 as 620. In this volume-enhanced scatter by this invention, the largest peak, labeled 620, is a Rayleigh scattering peak.

There are many important things that accrue from the above-entitled invention.

First, by use of the second group of laser peak(s), semiquantitative calibration can occur.

Second, one important aspect of the invention is that it reveals that there are additional peaks, which are shown labeled 650, 640, 645, and 660. It can be seen that just to the right of the largest peak (labeled 620) is a smaller peak (labeled 640). This peak is more than by a second, slightly larger, peak (labeled 645) on the opposite side of the largest peak (labeled 620). The peaks labeled 640 and 645 are what could be called Stokes-shifted and antiStokes-shifted peaks.

Third, again, in this case of the so-called “desired state”, there is a very much larger-than-expected intensity of the antiStokes peak (labeled 645) compared to the Stokes peak (labelled 640).

Importantly, in this desired high electrical impedance state, high heat mode for the two-terminal NANOR®-type CF/LANR component, there is, more than the expected amount of antiStokes peaks. It is much higher in amplitude than expected for an initial Boltzmann Statistic calculation, beyond any known calculated temperature, and beyond what could accrue due to curve shift to a very slight amount. This is direct evidence of phonon gain.

Fourth, it is discovered that phonon gain can be visualized and measured in real time, and used for control.

Fifth, this logarithmic presentation reveals additional advantages of the above entitled invention, which is the ability to discern optical phonons (labelled 640, 650, and 660, for example), as well as the acoustic phonons (labelled 620 and 625), and other vibrations, perhaps electronic, which are associated with applied magnetic fields or avalanche during transconduction.

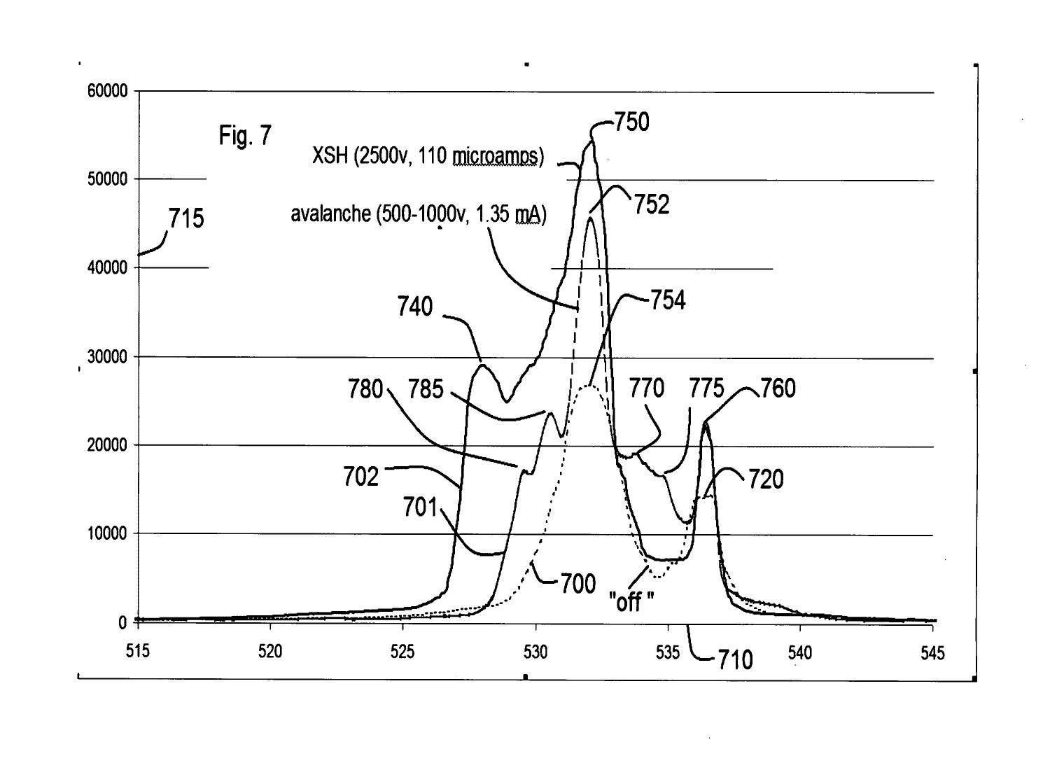

Turning to FIG. 7, curves 700, 701, and 702 are redrawn from FIGS. 3, 4 and 5 to enable comparison. Dual laser coherent stimulation was used. The responses of the ZrO2PdD-filled nanomaterial NANOR®-type CF/LANR component were examined in each electrically driven state, that is “off”, in avalanche mode, and in the optimal desired state where large amounts of energy are being released.

In the graph shown, the vertical axis (labeled 715) represents the intensity returned by backscatter along the reflected optical beam (labeled 300 in FIG. 1), with the sample (60 in FIG. 1; present as an electrical activated material ZrO2PdD, which has been inserted into a transparent cylinder, which itself was then inserted into the sample container, labeled 50 as shown in FIG. 1). The horizontal axis (labeled 710) plots the decreasing frequency to the right. It also plots, therefore, increasing wavelength as is denoted here by the wavelength in nanometers running from 515 to 545 nanometers.

For each curve shown (700, 701 and 702), the vertical axis represents the intensity returned by backscatter along the reflected optical beam (labeled 300 in FIG. 1).

In FIG. 7, the peak of the first laser (10) is shown with a peak at 532 nm, labeled in FIGS. 7 as 750, 752, and 754, for the “off” state, for the avalanche mode, and for the optimal desired electrically-driven state, respectively. In this volume enhanced backscatter used by this invention, the largest peaks, labeled as 750, 752, and 754, are Rayleigh scattering peak.

For FIG. 7, in curve 702, this nanomaterial component was electrically driven for the “desired state” at 2500 volts which produced about 0.11 milliamperes and maintained its high impedance during the very short run. This is what is also termed “desired mode” and only results from proper drive voltage, maintaining high impedance, avoiding quenching materials and quenching states.

There are many important things that accrue from the above-entitled invention.

First, again, by use of the second peak semiquantitative calibration can occur. The present invention has revealed a very good correlation of the peaks observed with what is expected for the palladium and the nickel, and the combination, contained herein.

Second, one important aspect of the invention is that it reveals that there are additional peaks, and can easily compare the additional peaks, which are shown labeled 720, 760, 775, 770, 780, 785, and 740. The peaks labeled 720, 760, 775, and 770 are what could be called Stokes-shifted peaks. In addition, as noted here, the peaks labeled 780, 785, and 740 are what could be called Stokes-shifted peaks.

Third, the response of the filled component, which is a two terminal electrical component, filled with the nanomaterial ZrO2PdD avalanche mode is shown by curve 701. For this, this nanomaterial component was electrically driven at 1000 volts initially which produced about 1.35 milliamperes. Thereafter, the voltage decreased with time. This is what is termed “avalanche mode” and usually results from excessive applied voltage, is usually undesirable because of loss of excess heat.

One hypothesis of the difference between the desired phonon gain mode and the avalanche (undesirable mode) is that the avalanche mode antiStokes are due to electronic vibrations, and are not the acoustic phonon mode associated with phonon gain (labeled 780 and 785, versus 740). The electronic vibrations do not produce the desired reactions.

Fourth, again, in the case of the “desired state”, there is a very much larger-than-expected antiStokes peak (labeled 740) compared to the Stokes peak (labeled 760). Importantly, in this desired high electrical impedance state, high heat mode for the two-terminal NANOR®-type CF/LANR component, there is, more than the expected amount of antiStokes peaks. It is much higher in amplitude than expected for an initial Boltzmann Statistic calculation, beyond any known calculated temperature, and beyond what could accrue due to curve shift to a very slight amount.

Fifth, it is salient that phonon gain can be visualized and measured as in the present invention. This new appeared phonon gain is direct Evidence of a new state, again corroborating the indirect Evidence of Cravens, Letts, and Hagelstein (vide supra).

The observed-“for the first time” phonon gain further explains the mechanism of heat generation, and even observed nuclear transmutation, such as the formation of de novo 4He.

In the desired excess heat state, the acoustic phonons are needed for energy transfer through the ZrO2 which acts as an electrical insulator.

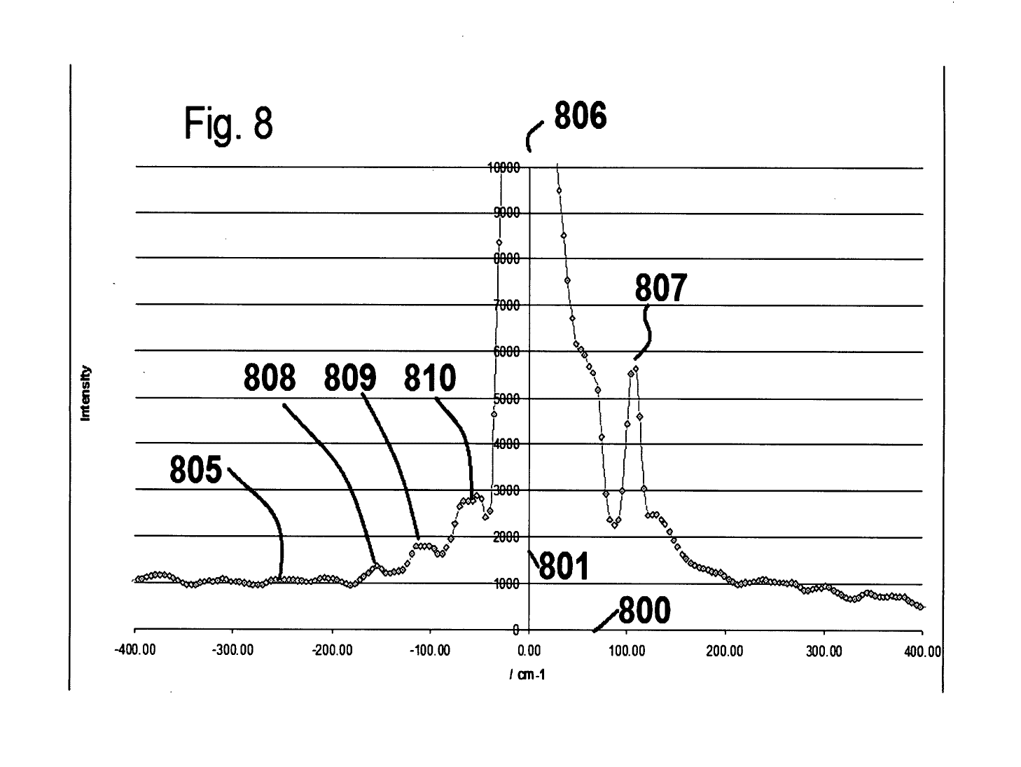

Turning to FIG. 8. This Figure, number 8, by way of graphical figure shows the response of the invention to the material ZrO2PdD and the simultaneous application of an applied magnetic field of an intensity circa 3 Tesla. For FIG. 4, this nanomaterial component was not electrically driven and Curve 805 in FIG. 8 specifically shows the observed optical output.

A horizontal axis (labeled 800) plots the decreasing frequency to the right. It also plots, therefore, increasing wavelength. In the curve shown (805), the vertical axis (labeled 801) represents the intensity returned by backscatter along the reflected optical beam (labeled 300 in FIG. 1).

The laser irradiation at 532 nm is of a power level on the order of 150 milliwatts.

In FIG. 8, the peak of the first laser (10 in FIG. 1) is shown with a peak at 532 nm, labeled in FIG. 8 as 806, which is located far above the graph. In this volume-enhanced scatter visualized by this invention, the largest peak (going beyond and above the graph), labeled 806, is a Rayleigh scattering peak.

There are many important things that accrue from the above-entitled invention. First, one important aspect of the invention is that it reveals that there are additional peaks, which are shown labeled 807 through 810. It can be seen that just to the right of the largest peak (labeled 806) is a smaller peak (labeled 807). Additional smaller peaks are seen on the opposite side of the largest peak (labeled 807). The peak labeled 807 and the group comprising 808 through 810 are what could be called Stokes-shifted and antiStokes-shifted peaks.

Second, the response of the filled component, which is a two terminal electrical component, filled with the nanomaterial ZrO2PdD to the applied magnetic field intensity is shown by curve 805. For this nanomaterial component it can be observed that the H-field produces antiStokes electronic vibrations (labeled 808 through 810). The electronic vibrations of do not produce the desired reactions, but with the desired mode they have been demonstrated to produce even more heat (Swartz 1, 2, 7, 12, 14, 15, 21).

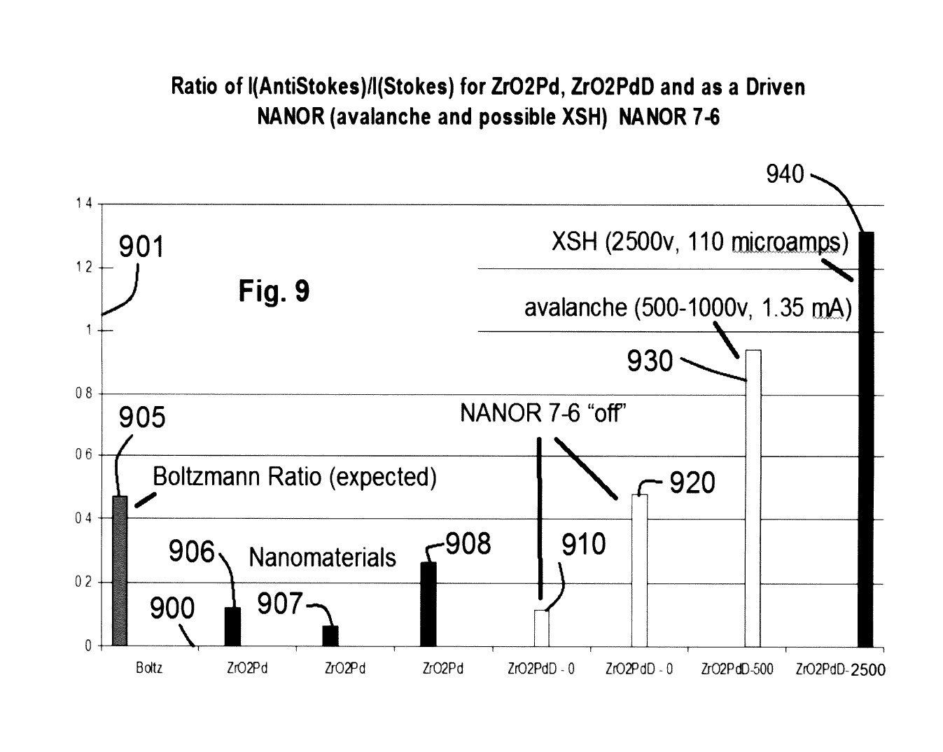

Turning to FIG. 9, a histogram is shown that summarizes some of the important results discovered by the above entitled invention.

The histogram shows the derived Boltzmann statistic ratio for the nanomaterials within the two terminal NANOR®-type CF/LANR component, before heavy hydrogen is added, and for the two-terminal component at several drive states after the heavy hydrogen is added.

The Boltzmann statistic ratio is derived from the intensity of the antiStokes peak divided by the intensity of the Stokes peak, and thus depends on frequency and the temperature. Normally, this is a number between 0.4 and 0.6, as can be seen (labeled 905).

The horizontal axis (labeled 900) shows and identifies eight different categories of said nanomaterial and said electrical drive states, and what is expected normally. The vertical axis (labeled 901) shows the amplitude of that Boltzmann statistic ratio.

The nanomaterial ZrO2Pd itself, without the addition of deuterons (heavy hydrogen), is shown in three samples (labeled 906 through 908). It can be easily observed that, and as described above, all of these Boltzmann statistic ratios are less than expected (905).

Then, after the same nanomaterial two terminal NANOR®-type CF/LANR component has heavy hydrogen added, those samples had a Boltzmann statistic ratio which ranged from the lowest value up to the normal expected Boltzmann ratio (confer samples labeled 910 and 920). This is essentially the case where the two-terminal component is “off” and there is no electric drive.

By contrast, where the two-terminal component is deuterided and in avalanche mode (labeled 930) the Boltzmann statistic ratio is greater than expected.

Even more in contrast, where the two-terminal component is both deuterided and in the desired mode (labeled 940), the Boltzmann statistic ratio is greater than 1.3. This value of the ratio is far outside of the range expected normally by temperature alone. This value of the ratio is beyond any known calculated temperature, and beyond what could accrue due to curve shift to a very slight amount.

This is evidence of phonon gain and is one of the great advantages of the above-entitled invention.

The results can be simply summarized in the following Table I which is elicited, visualized and measured by the above-entitled invention. Table 1 presents the above-described results of what is present in the associated Figures described above. What is shown in the table, and indicated in the first two rows, are the presence of the Stokes-type peaks at lower energies from the incident coherent stimulated radiation, and the presence of higher energy antiStokes-type peaks. The final row summarizes the ratio of the intensity of the antiStokes-type peak to the Stokes-type peak for each of the samples.

For the first column, shown is the result for nanostructured material which is not electrically driven, and therefore is in the “off” state. The second column denotes the result of the application of a very large magnetic fields intensity. The last two columns denote the results of the ZrO2PdD NANOR-type component in both the avalanche (non excess heat producing) mode and the desired state being the excess heat producing mode in the preferred embodiment.

TABLE 1
SUMMARY RESULTS
Boltzmann Factor - The Ratio of the Intensity of AntiStoke-type peaks
to the Stoke-type peaks as compared to the Expected Boltzmann Ratios
for LANR (LENR) nanomaterials and ZrO2PdD in NANOR

| | undriven | H-field | Avalanche | XSH |
|---|---|---|---|---|
| Stokes | + | + | + | +− |
| antiStokes | 0/−− | −/+ | + | +++ |
| I(aS)/(S) | <<BS | <BS | BS | >BS greater |

It can be seen that the present invention has incredible utility, without impugning any of its other features, in determining which state the material or component is, and in real time, even as it is electrically driven. This thereby allows the user of the present above-entitled invention to generate phonon gain and to therefore control the desired reaction.

### Other Material Science and Engineering

### Uses of the Present Invention

The present invention does not depend upon excess heat. However, it generates excess heat in the preferred embodiment, and then visualizes it, controls it, and utilizes it, when it occurs. However, this invention is still useful without heat, even though in the preferred embodiment it is produced.

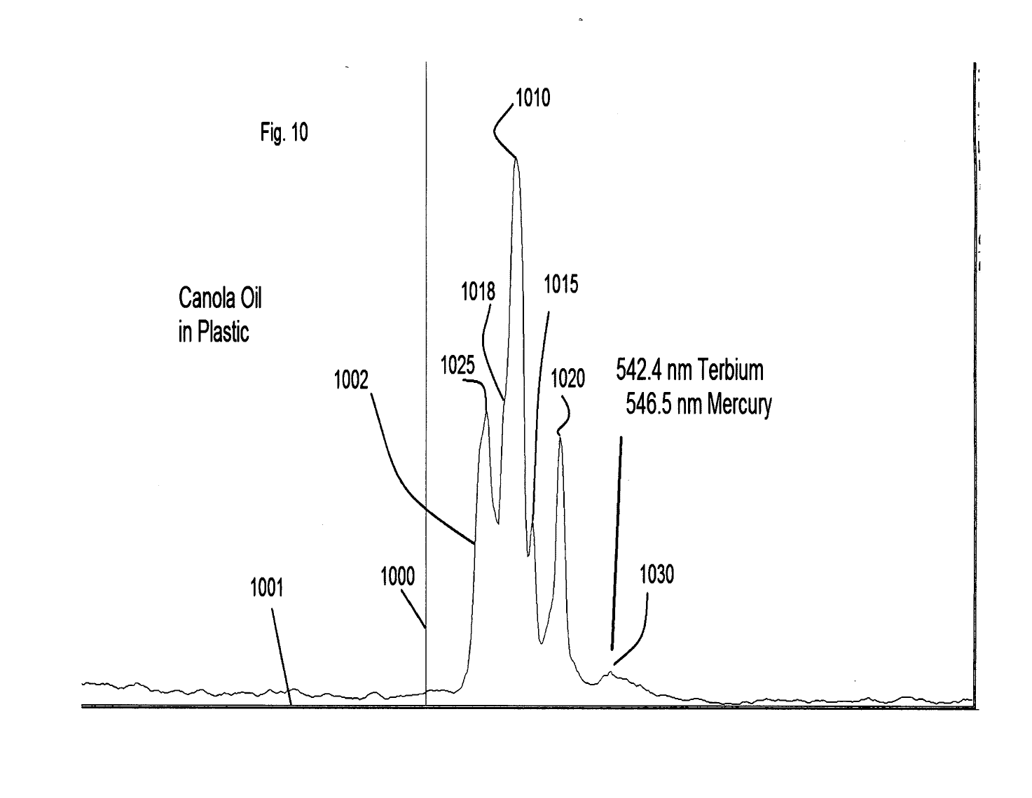

As an example of such alternate use; turning to FIG. 10. FIG. 10 shows a curve obtained by the above entitled invention when used to examine canola oil held in plastic, which itself was then inserted into the sample container, labeled 50, as shown in FIG. 1. For this run, there was neither any electrical drive nor applied magnetic field.

The implication is that the present invention has made visible the reason why canola oil is so appreciated in 3D printing.

Dual laser coherent stimulation is the preferred embodiment of the present invention, but other markers can be used for calibration. Here, the peaks 542.4 nm from terbium and 546.5 nm from mercury are used (labeled as 1030).

Thus, in the curve shown (labeled 1002), the vertical axis represents the intensity returned by backscatter along the reflected optical beam (labeled 300 in FIG. 1), with the sample (60 in FIG. 1; present as canola oil held in plastic). A horizontal axis (labeled 1001) plots the decreasing frequency to the right. It also plots, therefore, increasing wavelength.

In FIG. 10, the peak of the first laser (10 in FIG. 1) is shown with a peak at 532 nm, labeled in FIG. 10 as 1010. In this volume enhanced dual laser backscatter invention, the largest peak, labeled 1010, is a Rayleigh scattering peak.

It can be seen that just to the right of the largest peak (labeled 1010) are two smaller peaks (labeled 1015 and 1020). These peaks are accompanied by two slightly larger, peaks (labeled 1025 and 1018) on the opposite side of the largest peak (labeled 1010). The peaks labeled 1015, 1020, 1025 and 1018 (partially obscured by the peak at 1010) are what could be called Stokes-shifted and antiStokes-shifted peaks.

What are seen to the left of the highest peak (1010) are termed the antiStokes peaks.

There are many important things that accrue from the above-entitled invention.

First, by use of the second group of peaks (here from a fluorescent lamp), semiquantitative calibration can occur.

Second, another important aspect of the invention is that it reveals that there are additional peaks, including those which are saliently shown labeled 1015, 1020, 1025 and 1018.

Third, importantly, for this material there is, more than the expected amount of antiStokes peaks. It is much higher in amplitude than expected for an initial Boltzmann Statistic calculation.

Fourth, this Evidence, observable through the above-entitled invention, permits recognition of important new materials, such as Canola oil, which has great utility as a high temperature nozzle lubricant, as used for 3D printing.

The above-entitled invention also reveals under what conditions this material is exceptional. The unusual observations here were not observed when canola oil was contained in glass.

That material is unique for 3D printing and facilitates filament loading, but until now it was never clear exactly why.

Fifth, it is discovered that phonon gain can be seen. It corroborates as direct Evidence of how to find and identify important new materials for 3D printing, biomedical flow, aerodynamic fuel management, optimum fluid flow, and the like.

### Implications of the Above-Entitled Invention

The utility of the above entitled invention can be saliently seen because its visualization of the material properties in real time have already revealed new and great insights into the workings of these LANR nanostructure, and other, systems. And even the USPTO would have to admit that control or such clean energy production systems are of great utility.

In addition, as but one example, this invention has detected phonons which were not observed directly before. This is critical because acoustical phonons do have a role in LANR and cold fusion when the nanomaterial ZrO2PdD, and the like, are used. Although optical phonons had previously been considered key to the energy transfer of 4He* formed de novo to the thereafter appearing heat, by the basis of the direct Evidence obtained by the above-entitled invention it can be seen (for example confer FIGS. 4 through 8) that the acoustical phonons are important, too. The acoustic phonon density increases dramatically in the excess heat mode, compared to both the “off” state and compared to the avalanche mode.

In retrospect, although not considered before, what has been revealed by the above-entitled invention is quite important. In the used zirconium oxide nanostructured materials, one would not expect the lightweight (compared to the zirconium and palladium) hydrogen nuclei to transverse the electrically insulating zirconium oxide, but rather to remain as an alloy in the group VIII metallic palladium (or nickel as is also used).

Therefore in retrospect, consistent with FIGS. 4 through 8, it is obvious that the acoustic phonons do have a role, must have a role, and in fact can be observed directly with the above-entitled invention. This result is from the inability of hydrogen (deuteron or protium) to penetrate the ZrO2 easily, because ZrO2 is an electrical insulator. This heralds further utility.

Another important utility of the above entitled invention is that for these nanostructured materials in NANOR-type components, the XSH Mode increase of antiStokes is so high that it may “push” reactions other than excess heat production, such as currently known low-level emissions, and currently known transmutations (such as de novo 4He production). In fact, by such phonon gain other reactions can be now controlled. These reactions include an alternative to hydrocarbons to produce energy, with applications including heating, transportation, electricity production, medicine, including artificial organs, and space travel.

In the preferred embodiment of the present invention, the nanomaterial is preloaded, and electrically activated. This present invention will also work with electrically loaded materials and nanomaterials, gas loaded materials and nanomaterials, and 3D printed preloaded materials and nanomaterials, as well as diverse other systems. These include materials which load hydrogen, including Group VIII, Group IVb and Vb, and some rare earth, elements, including palladium, nickel, titanium, nickel, cerium, lanthanum, niobium, tantalum, thorium, vanadium, zirconium, and their alloys and composites and nanostructured materials constructed from these elements. This present invention will also work with magnetically, pressure, optical, heat and flux activation, as well as diverse other systems.

The present invention is applicable to materials which do not exhibit excess heat (observable heat beyond that of a joule thermal control) or even heat, but are involved in dynamic processes such as lubrication, fluid flow, chemical reactors, medical testing, 3D-printing and the like. As but one example, the control of 3D printers involves high temperature extrusion of a variety of materials ranging from polylactic acid, ABS (acrylonitrile butadiene styrene), polypropylenes, nylons, and metal filled filaments. The latter include bismuth, bronze, copper, and tungsten. Some of the above generate problems at the extruders in said 3D printers. However, canola oil is unique for enabling such passage through the extruders and minimizing the likelihood of problems at that site. The present invention will lead to an entire new cohort of such materials because the phonon gain required for such extruder enablement can be visualized.

Other examples of high utility applications of the above-entitled invention include monitoring and control of fuel consumption in internal combustion engines and fusion engines, and of materials prepared through chemical reactors, and of biosystems treated with pharmaceuticals and other materials.

### Utility of the Present Invention

The present invention has incredible utility because the generated spectra are in real time and enable control of those reactions. This type of backscatter of two wavelengths, from a hydrogen loaded material which is driven by electrical and/or magnetic field intensity which is applied, is semiquantitative, and is shown to be useful, and to be of great utility, capable of opening new types of controllable-in-real-time materials science, metallurgy, material engineering, electrical engineering, and electrophysics.

The present invention has incredible utility because it enables examination of a number of nanomaterials, both in their free form and even when they are inserted in a system, or apparatus, such as a NANOR-type nanostructured component. And as can be seen by the diversity of what is revealed (FIGS. 2 to 10) those desired products may range from heat, to phonon gain, to entirely new desired reactions, to material flow, to the production of new materials.

The present invention has incredible utility, including that it has already revealed the relative absence of antiStokes-type peaks in several types of nanostructured materials. This is quite important because for the case where it is observed that there is a relative absence of antiStokes-type peaks, the result is that the expected Boltzmann statistics ratio level is far below what is expected. This has taught more about the mechanism.

The present invention has incredible utility, including in the development new materials, of higher power gain materials, as well as in the design of improved components to maximize the desired reactions, and to maximize generated products.

The present invention has incredible utility because it has already discovered, for the first time, that there exist increased levels of antiStokes-type peaks both in select nanostructured materials (FIGS. 2 through 9) and other select materials (FIG. 10). This demonstrates that they are not only unique, but enables their development, and even for some like the nanomaterials, control.

The present invention has incredible utility because it has already revealed, with new direct evidence, that when nanostructured NANOR-type components are driven in Avalanche Mode, there can be observed increases of the intensity of the antiStokes-type peaks. This returns to normal (or slightly increases as expected for temperature rise) the expected Boltzmann statistics ratio.

The present invention has incredible utility because it has already discovered, for the first time, that there exist multiple low level antiStokes-type peaks which appear in the presence of a simultaneously applied magnetic field of high intensity.

The present invention has incredible, if not utmost, utility because it has already revealed, with new direct evidence, that when nanostructured NANOR-type components are driven in excess heat (XSH) Mode, there is a major, dramatic increase of antiStokes components. This results in a Boltzmann statistics ratio (Boltzmann factor) which is at a level far greater than that expected for the normal Boltzmann statistics ratio. And that increased difference heralds phonon gain. Furthermore, the present invention has utmost utility because it has already revealed, with new direct evidence, that when nanostructured NANOR-type components are driven in Avalanche Mode, the antiStokes-type components which appear are different in type, location, and amount, from those which appear during the excess heat producing “desired mode”. Simply put, the XSH Mode appears to create antiStokes components NOT seen in avalanche; and they can be directly in real time observed by the present invention, which is of therefore great utility.

### Other Embodiments of the Present Invention

In another embodiment of the present invention, there are a variety of lasers that could used as the second laser for calibration, such as Ar (488 nm, 514.5 nm), Kr (530.9 nm, 647.1 nm), He/Ne (623 nm), other LED Diodes (e.g. 782 nm or 830 nm), Nd/YAG (1064 nm), and tunable lasers.

In addition, in yet another embodiment of the present invention, a fluorescent light source could be used.

In another embodiment of the present invention, the control circuits can also utilize simultaneous empirical system identification control (Swartz 12).

Furthermore, computation systems can be added to detect, maintain, and thereby control. These range from simple Arduino-type systems to more complicated microprocessors which are linked in parallel and connect to further types of sensors.

In another embodiment of the present invention, the visualizations, detections, and calculations can be arranged for improving predictability of systems, or in estimating the lifetime of those systems and materials.

The original specification, accompanied by the figures of said specification, clarify and define these matters to one skilled in the art by providing a complete description.

Modification of the invention herein disclosed will occur to persons skilled in the art. It is understood that the specific embodiments of the invention shown and described are but illustrative and that various modifications can be made therein without departing from the scope and spirit of this invention, and all such modifications are deemed to be within the scope of the invention as defined by the appended claims.

### SUMMARY OF INVENTION

In accordance with a preferred embodiment of the invention, there is disclosed a machine for observing phonon gain to control desired reactions of an electrically driven hydrogen loaded material comprising: a container with at least two optical ports containing a sample of said material, a power supply and wiring connections to enable driving a sample to be examined, a power supply to drive at least two lasers, a controller to regulate the output of said lasers, a beam path to enable illumination of the sample, a controller to regulate control of electric power delivered to said sample enabling driving in more than one state, a detector system to examine the backscatter radiation from the sample which is illuminated, a second beam path to enable said backscatter to reach said detector system, a computation system to separate the frequencies of said backscatter and to determine the intensities and distribution of said backscatter, and a second computation system to compare the desired intensities and distribution of said backscatter and to compare that to what was detected and to derive changes as necessary for said power supply which enables driving and controlling said hydrogen loaded material.

1. A machine to detect phonon gain in an electrically driven hydrogen loaded material to control desired reactions comprising:
a container with at least two optical ports and at least two electrical ports;
a material which can provide at least one desired reaction when electrically driven;
a power supply and wiring connections to enable said electrical driving of said material;
a power supply to drive at least two optical sources;
an optical controller to regulate the output of said optical sources;
a beam path to enable illumination of the sample;
a electrical power controller to regulate control of electric power delivered to said material enabling driving in more than one state;
an optical detector system to examine the backscatter radiation from the material which is illuminated;
a second beam path to enable said backscatter to reach said detector system;
an means to separate the frequencies of said backscatter;
a computation system to determine the intensities and distribution of said backscatter;
a second computation system to compare the desired intensities and distribution of said backscatter and to compare that to what was is preferred so as to derive the changes necessary for said electric power controller to change said power supply driving said material.

2. A machine as in claim 1 where said material contains a member of the group consisting of PdD, NiD, ZrO2PdD, ZrO2PdNiD and ZrO2NiD.

3. A machine as in claim 1 where said material contains canola oil

4. A machine as in claim 1 where said optical sources are two lasers.

5. A machine as in claim 1 where said optical sources are a laser and a second optical source of known optical output.

6. A machine as in claim 1 where said desired state produces heat.

7. A machine as in claim 1 where said desired state produces effective lubrication.

8. A machine as in claim 1 where said computation detects phonon gain.

9. A machine as in claim 1 where detector system is comprised of a member of the group consisting of a grating, blazed grating, a holographic grating, or prism, and a member of the group consisting of a CCD, photographic plate, an android type telephone, and a 1D dimensional optical detector.

10. A method for detecting phonon gain in a material comprising:
positioning a container with at least two optical ports and at least two electrical ports;
providing a sample capable of at least one desired reaction;
enabling an electrical power supply and wiring connections to driving said sample to be examined;
powering at least two lasers while controlling the output of said lasers;
illuminating said sample using said lasers;
regulating the control of said electric power supply to drive said sample into said desired reaction state;
detecting and examining the backscatter radiation from said sample undergoing said illumination;
separating the frequencies of said backscatter to determine the intensities and distribution of said backscatter by said frequency; and
comparing the desired intensities and distribution of said backscatter to what is expected to said desired reaction and
deriving changes as necessary for said control of said power supply to enables driving said sample in said reaction state.

11. A method as in claim 10 where said material contains a member of the group consisting of PdD, NiD, ZrO2PdD, ZrO2PdNiD and ZrO2NiD.

12. A method as in claim 10 where said material contains canola oil

13. A method as in claim 10 where said computation and derivation is by microcomputer or microprocessor means.

14. A method as in claim 10 where said material is used for lattice assisted reactions of the type which generate a member of the group consisting of heat, electricity, propulsion, or new materials.

15. A method as in claim 10 where said detecting and examining is done by a member of the group consisting of a grating, blazed grating, a holographic grating, or prism, and a member of the group consisting of a CCD, photographic plate, an android type telephone, and a 1D dimensional optical detector.

16. A machine to control desired reactions in an electrically driven hydrogen loaded material comprising:
a container with at least two optical ports and at least two electrical ports;
a material which can provide at least one desired reaction when electrically driven;
a power supply and wiring connections to enable said electrical driving of said material;
a power supply to drive at least two optical sources;
an optical controller to regulate the output of said optical sources;
a beam path to enable illumination of the sample;
a electrical power controller to regulate control of electric power delivered to said material enabling driving in more than one state;
an optical detector system to examine the backscatter radiation from the material which is illuminated;
a second beam path to enable said backscatter to reach said detector system;
an means to separate and detect the frequencies of said backscatter;
a computation system to determine the intensities and distribution of said backscatter;
a second computation system to compare the desired intensities and distribution of said backscatter and to compare that to what was is preferred so as to derive the changes necessary for said electric power controller to change said power supply driving said material.

17. A machine as in claim 16 where said material contains or is a member of the group consisting of PdD, NiD, ZrO2PdD, ZrO2PdNiD and ZrO2NiD.

18. A machine as in claim 16 where said computation is made by a member of the group consisting of computer, microcomputer, or microprocessor.

19. A machine as in claim 16 where said means to separate and detect said frequencies is done by a member of the group consisting of a grating, blazed grating, a holographic grating, or prism, and a member of the group consisting of a CCD, photographic plate, an android type telephone, and a 1D dimensional optical detector.

20. A machine as in claim 16 where said material is used for producing reactions which are a member of the group consisting of heat, electricity, propulsion, or new materials.
